(19) United States
(12) Patent Application Publication
(10) Pub. No.: US 2014/0021135 A1
(43) Pub. Date: Jan. 23, 2014

(54) TREATMENT OF WATERS WITH MULTIPLE CONTAMINANTS

(71) Applicants: John E. Sawyer, Charleston, WV (US); Arthur L. Lucas, Proctorville, OH (US); Vincent Maurice Davis, Charleston, WV (US); Bernard Duane Dombek, Charleston, WV (US); George Ernest Keller, II, South Charleston, WV (US)

(72) Inventors: John E. Sawyer, Charleston, WV (US); Arthur L. Lucas, Proctorville, OH (US); Vincent Maurice Davis, Charleston, WV (US); Bernard Duane Dombek, Charleston, WV (US); George Ernest Keller, II, South Charleston, WV (US)

(73) Assignee: LIBERTY HYDRO, INC., SOUTH CHARLESTON, WV (US)

(21) Appl. No.: 14/009,682

(22) PCT Filed: Mar. 27, 2012
(86) PCT No.: PCT/US12/30673

§ 371 Date: Oct. 3, 2013

Related U.S. Application Data
(60) Provisional application No. 61/472,326, filed on Apr. 6, 2011.
(60) Provisional application No. 61/542,869, filed on Oct. 4, 2011.
(60) Provisional application No. 61/542,881, filed on Oct. 4, 2011.

(30) Foreign Application Priority Data
Oct. 14, 2011 (US) 13/274273

(51) Int. Cl. C02F 1/44

(52) U.S. Cl. CPC C02F 1/445
USPC 210/652; 210/195.2

(57) ABSTRACT

A process for a purification of water with multiple contaminants including dissolved solids. The process may involve one or more steps of separating oil and water, metals precipitation, dissolved air flotation (DAF), filtration, forward or reverse osmosis and crystallization. An improved DAF unit is described which increases air dissolution to oxidize impurities and improve flotation. Various embodiments of staged osmotic membrane systems are provided to generate an essentially pure water stream and a highly concentrated solute stream. In some embodiments, reverse osmosis and nanofiltration units are employed in a staged manner. In other embodiments, all stages are reverse osmosis units and the osmotic pressure of each stage is adjusted by the provision of a solution on the low pressure side of the reverse osmosis membrane using nanofiltration membranes. Various recycle options are employed to improve the efficiency of the systems. Also, customized reverse osmosis membrane cartridges and flat reverse osmosis membranes are disclosed.

### CROSS REFERENCE TO RELATED APPLICATIONS

This application is a non-provisional of U.S. provisional application No. 61/542,869, filed on 4 Oct. 2011, a non-provisional of U.S. provisional application No. 61/542,881, filed on 4 Oct. 2011, a non-provisional of U.S. provisional application No. 61/472,326, filed on Apr. 6, 2011, and a continuation of U.S. patent application Ser. No. 13/274,283, filed on 14 Oct. 2011, which, in turn, is a non-provisional of U.S. provisional application No. 61/393,020 filed on 14 Oct. 2010, the disclosures of which are hereby incorporated by reference in their entirety.

### BACKGROUND OF THE INVENTION

1. Field of the Invention

The present invention is generally directed to removing contaminants found in water, and more specifically, toward removal of contaminants found in water produced from oil and gas drilling.

2. Description of the Prior Art

The hydraulic fracturing technique has been used for many years in the United States to enhance oil and gas recovery. Current drilling techniques involve drilling vertically to the level of the shale and then horizontally into the shale layer. The horizontal drilling provides greater contact area for fracturing and consequently a high gas yield.

Hydraulic fracturing typically involves the use of high pressure water to fracture the shale layer and release the gas. The fluid used for this purpose is primarily water but also contains a proppant (about 9.5%) and chemical additives (about 0.5%). The proppant is typically fine sand or ceramic particles and is used to prop open the minute fractures created in the shale to allow the gas to flow out.

Later in the process, the fluid returns to the surface via flow-back. The amount of flow-back can be significant and it is not atypical to have several hundred thousand gallons or more. This flow-back fluid must be stored, recycled or removed from the site to a suitable disposal area. After the flow-back fluid, the stream is considered “produced water” which is natural water from the shale layer. The flow-back fluid and produced water are collectively referred to as “frac water.” The frac water contains the original fluid components as well as dissolved minerals and impurities from the shale formations. Typically, the largest component is sodium chloride though the frac water will generally contain calcium ions, organic compounds, and particulate and heavy metals or ions such as barium and strontium ions. The composition of frac water can vary considerably depending on the location and geology of the area.

In general, there are several contaminants in surface waters that are of considerable concern due to their effects on wildlife as well as humans. The contaminants that are soluble are measured collectively as Total Dissolved Solids (TDS) and are typically metal salts of acids. A high TDS value has been shown to be detrimental to aquatic life. At the same time, a level of TDS that is too low is also detrimental to aquatic life.

Another contaminant is organic compounds that are residues of oil or gas production. These may be toxic, or simply block removal of the TDS by fouling the reverse osmosis membranes. Another class of contaminants is heavy metals, which must be separated from the salt residue to allow reuse of the salts. A final class of contaminant is suspended solids, which must be removed to prevent fouling of the reverse osmosis membrane.

The process of crystallization requires a supersaturated solution. This is most often created by evaporating solvent from the solution. For heat sensitive materials, this evaporation is conducted at low temperatures, and sub-atmospheric pressures. The heat input to turn the solvent into vapor is quite large, and every effort is made to capture and reuse that heat. However, the energy requirements are still relatively large, even with the additional capital expenditures required for the equipment necessary to recover and reuse the thermal energy. A process with greatly reduced energy costs is needed.

### SUMMARY OF THE INVENTION

In a first aspect, the present invention relates to a reverse osmosis system for treatment a feed solution is fed through said plurality of membrane units to produce a highly concentrated solute stream and a substantially pure water stream. The system includes a plurality of membrane units each containing at least one membrane, said membrane units being arranged in series and there being a sufficient number of membrane units to ensure that a pressure drop across each membrane is maintained within operational limits by spreading a total pressure drop for said system across said plurality of membrane units, and a recycle system for recycling solution from each membrane unit to a previous membrane unit in said series.

In another aspect, the present invention relates to a process for treatment of a feed solution to produce a highly concentrated solute stream and a substantially pure water stream. In the method the feed solution is passed through a first reverse osmosis membrane unit to produce a permeate and a rejectate, and the rejectate from the first reverse osmosis membrane unit is passed through at least a second reverse osmosis membrane unit on a high pressure side of a reverse osmosis membrane to produce a permeate and a rejectate, wherein a solute solution having an osmotic pressure 1.7-7 MPa lower than said rejectate is passed along a low pressure side of said reverse osmosis membrane of said at least a second reverse osmosis membrane unit to maintain a pressure drop across said reverse osmosis membrane of less than about 750 psig.

### BRIEF DESCRIPTION OF THE DRAWINGS

FIG. 1 is a flow diagram of equipment that may be used to carry out water treatment.

FIG. 2 depicts an embodiment of an enhanced dissolved air flow system in accordance with the present invention.

FIG. 3 depicts an embodiment of a staged membrane purification system in accordance with the present invention employing several stages with semi-permeable membranes and splitting the rejectate streams for recycle.

FIG. 4 depicts another embodiment of a staged membrane purification system in accordance with the present invention employing several stages with semi-permeable membranes and recycle of the rejectate streams.

FIG. 5 is a schematic representation of equipment which can be used for a staged RO process in accordance with the present invention for the production of concentrated salt brine and substantially pure water from a salt solution.

FIG. 6A is a schematic representation of a cross-sectional view of a spiral wound cartridge with an additional inlet in accordance with the present invention.

FIG. 6B is a schematic representation of a cross-section of a spiral wound cartridge with layered RO and nanofiltration membranes and separate outlets for the rejectate or concentrate, lower concentration permeate, and feed.

FIG. 6C is a schematic representation of a cross-section of a single layer from the spiral wound cartridge with layered RO and NF membranes shown in FIG. 6B.

FIG. 7 depicts an embodiment of a staged membrane purification system in accordance with the present invention employed several stages of RO membranes.

FIG. 8 depicts an alternative embodiment of a staged membrane purification system in accordance with the present invention employed several stages of RO membranes.

FIG. 9 depicts a crystallization process in accordance with the present invention using a reverse osmosis membrane.

FIG. 10 depicts an oscillating impeller for a flat membrane design.

FIG. 11 depicts a flow diagram of reverse osmosis equipment that can be used with an alternative crystallization process in accordance with the present invention.

FIG. 12A shows the original used frac water employed in Example 4.

FIG. 12B shows the material skimmed from the DAF tank after subjecting the original used frac water to DAF treatment in Example 4.

FIG. 12C shows the product from the DAF tank of Example 4.

FIG. 12D shows the filtrate obtained by filtration of the DAF product of FIG. 12C through a 1 micron filter.

FIG. 12E shows the filtrate obtained by filtration of the 1 micron filter filtrate after further filtration through a 0.45 micron filter.

### DETAILED DESCRIPTION OF EMBODIMENTS OF THE INVENTION

The present invention is generally directed to methods for removing contaminants found in waters such as produced water from oil and gas drilling. The invention is also suitable for a variety of other separation processes, particularly those wherein dissolved solids need to be removed from solvents. Thus, the present invention can be employed in desalination processes, optionally with co-generation of salts. The invention can also be employed to treat various types of waste waters.

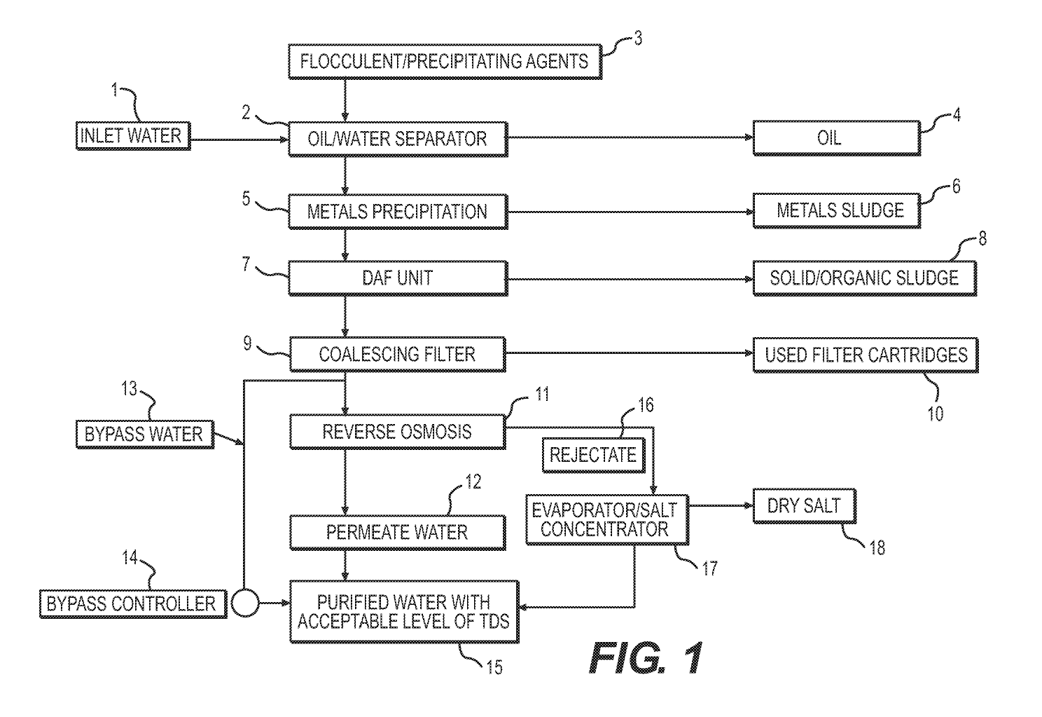

One use of the present invention is to treat frac water containing dissolved sodium chloride, among other impurities. Certain impurities can be removed using one or more of the steps shown in FIG. 1. The osmotic membrane systems of the present invention can then be used to provide a substantially pure water stream and a highly concentrated sodium chloride stream from which the sodium chloride can be recovered. For example, starting from a solution of 1-20 wt % of sodium chloride, the solution can be concentrated to concentrations up to about 20-22 wt % of sodium chloride.

In various embodiments of the present invention, one or more of the pieces of equipment shown in FIG. 1 may be employed, depending on the particular need for contaminant removal.

Untreated produced water which may be frac water may be decanted and coalesced to separate the light fracing fluid and/or organic compounds from the water. Thus, inlet water 1 may be fed to oil/water separator 2, optionally together with flocculent and/or precipitating agents 3. Oil 4 may be removed from oil/water separator 3 as a waste stream. Additionally, other types of process conditioning such as the addition or removal of heat and pressure may be applicable and common in practice to separate organic compounds and water emulsions.

Another step may involve heavy metal removal using a metal precipitator 5. Heavy metals and/or sludge 6 may be precipitated out of the produced water such that the final salts will not be contaminated with toxic heavy metals, and can be reused for other commercial purposes. Heavy metal removal treatments are well known, and include adding sulfate to precipitate barium, adjusting the pH to the slightly basic and allowing iron, manganese, aluminum, and similar metals to hydrate and precipitate. To speed the hydration and flocculation, additional compounds such as flocculants and/or precipitating agents 3 may be added to the water. If necessary, treatments for additional contaminants such as selenium and mercury may be added.

Another step in the process may involve treatment of the water with a dissolved air flotation step in a dissolved air flotation (DAF) unit 7 to remove the suspended solids, and a portion of the residual (miscible and immiscible) organic compounds. Preferably, oils and heavy metals, as well as any sludge, are removed prior to feeding the fluid to the DAF unit to avoid fouling of the DAF unit. The DAF unit will produce a waste stream of solids and/or organic sludge 8. As standard DAF systems are not as effective as desired, an enhanced version of a DAF system may be used according to the present invention.

Any remaining micelles of immiscible organic compounds may be removed by a coalescing filter 9. The coalescing filter 9 is designed to protect downstream processes, such as those involving the use of reverse osmosis membranes, from premature fouling and operation inefficiency. Used filter cartridges 10 from coalescing filter 9 are periodically discarded. Finally, the water may be passed through a reverse osmosis (RO) unit 11 to remove dissolved solids, such as metal salts of acids. In most cases, these will be primarily metal chlorides with some sulfates. RO unit 11 may include a processing train of conventional RO membranes along with special Selective Membrane Units (SMU's). The permeate water 12 obtained from RO unit 11 may be discharged, or reused in the drilling process. If discharged, permeate water 12 may be blended with a suitable amount of RO bypass water 13 using bypass controller 14 to provide purified water 15 with an acceptable level of total dissolved solids (TDS) as well as the necessary electrolytes for aquatic life prior to discharge, and the pH may also be adjusted, if necessary. The rejectate 16 from RO unit 11 may be fed, for example, to an evaporator/salt concentrator 17 to produce dry salt 18. Alternatively, RO unit 11 can be replaced by a crystallization unit in accordance with the present invention.

While all of the steps shown in FIG. 1 may be necessary, in some instances some of the steps will not be needed for treatment of specific waters. The major benefit from the present invention is the ability to remove multiple contaminants from contaminated waters in a more cost effective manner than other removal methods, with a goal of producing pure water and either a highly concentrated salt solution, or a dry salt stream.

DAF is a method of removing suspended particles from a liquid by dissolving air at high pressure, releasing the pressure, and allowing the air bubbles to nucleate around the suspended particles, floating them to the surface. Once on the surface, the particles can be effectively removed by any suitable mechanical means such as skimming. Preferably, the air bubbles are introduced into the DAF unit 7 in a much smaller form or are broken into much smaller bubbles after introduction into the DAF unit 7. In one embodiment, the air bubbles are first broken into smaller bubbles, preferably at low pressure, and then the pressure is raised to a higher pressure, to further reduce the size of the bubbles. It has been found that reducing the size of the bubbles and/or increasing the pressure dissolves more of the air into the DAF fluid. Alternatively, the air bubbles may be broken into smaller bubbles after the pressure is raised in the fluid. The smaller radius of the air bubbles increases the internal pressure to a pressure higher than the bulk fluid pressure due to the surface tension of the liquid. This effect is more pronounced for a fluid such as water with a relatively high surface tension. The air dissolution may be enhanced by holding the fluid under pressure for a period of time to allow the air dissolution to proceed. After the air is dissolved, the pressure is released, and the dissolved air nucleates on suspended solids, floating them to the surface. By enhancing the amount of air dissolved, the flotation is thereby enhanced as well, making separation more thorough, efficient and quicker.

As an added benefit, the additional air dissolved in the fluid may also oxidize organic compounds dissolved in the fluid, thereby facilitating their removal from the fluid. Thus, ppm levels of contaminants such as benzene, toluene, xylene, and other noxious organic molecules may be removed or otherwise neutralized as a result of this oxidation.

Among the methods of reducing the size of the air bubbles to effect increased dissolution of air is to pass the fluid stream with bubbles through a device to break the bubbles into smaller bubbles. Multiple passes through such devices may be necessary to achieve the desired bubble size, and thus the desired dissolution of air in the fluid. One option is to pass the fluid through small diameter nozzles at high flow rates. Another option is to shear the fluid to mix the bulk fluid and stretch and break the bubbles into smaller bubbles. The fluid may also be passed through a device having multiplicity of small orifices having diameters of about 2-5 millimeters, preferably, 2-3 millimeters at velocities in the range of 3 to 7 meters per second. Preferably, the fluid is impinged on a surface after traveling through the fluid for a distance of about 2 to 10 millimeters, preferably about 5 millimeters.

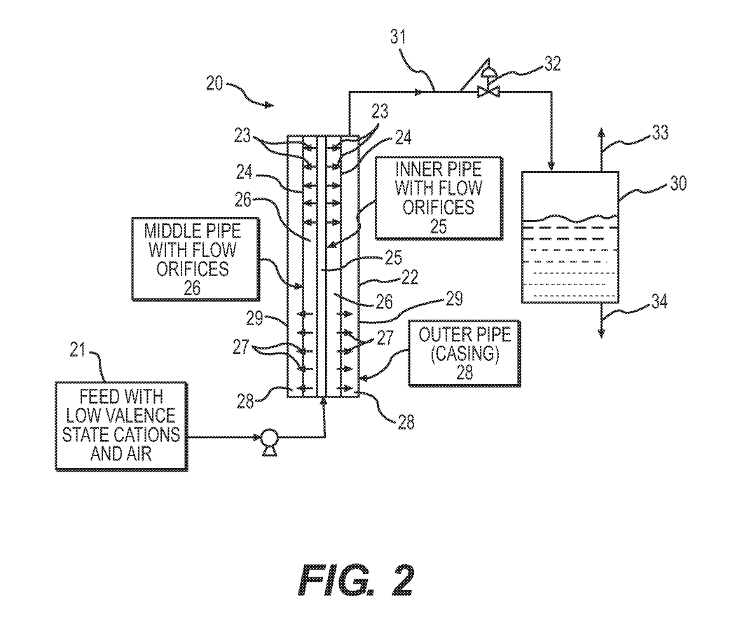

This enhanced dissolved air flotation device (EDAF) unit 20, shown in FIG. 2, is capable of removing or oxidizing ppm levels of organic materials left in the water, and removing essentially all of the suspended solids and micelles which are otherwise too small to coalesce. For instance, ferrous (Fe⁺²) ions are oxidized to the ferric (Fe⁺³) state. While this process occurs naturally in the presence of oxygen at favorable pH levels, the reaction rate may be increased by increasing the amount of oxygen present in the water, leading to faster oxidation and more rapid and complete removal. This process also works for other metals such as manganese.

The steps in the conventional treatment process involve adjusting the pH to a range favorable for the treatment to occur, oxidizing the iron to the insoluble Fe⁺³ (ferric) species and the manganese to Mn⁺⁴, causing the insoluble species to agglomerate and removing the large relatively dense agglomerates from the solution. The entire process is slow due to the reaction rates involved, and requires considerable sized detention ponds. Faster reaction rates would permit reduction of the size of the retention ponds required and make the process easier to control. Typically, permanganate is used to oxidize Mn⁺² containing streams to produce the insoluble Mn⁺⁴. The kinetics of this reaction are temperature dependent, and do not work well in cold weather.

In the EDAF system 20 of the present invention, the pH of the feed 21 or in the aeration unit 22 or DAF unit 30 may be adjusted to the basic range, i.e. a pH of 7-10, more preferably, pH of 8-9. This has been shown to reduce the dissolved iron level from around 11 ppm to around 2 ppm in less than a minute. In manganese containing streams, the oxidation can be conducted under basic conditions even at the low temperatures encountered in winter.

Thus, one method for carrying out this stage of the process involves increasing the oxidation rate in water by passing the water containing air bubbles at 500 to 1500 kPa through a multiplicity of orifices 23, 27 of 2 to 5 millimeters diameter at a velocity of 3 to 10 M/s and preferably at 3 to 7 M/s, impinging the stream on a solid surface 24 after traveling a distance of 2 to 10 millimeters, changing flow direction and, preferably, repeating these steps until the water is substantially saturated with air. Thus, as shown in FIG. 2, the water 21 with low valence state cations of, for example, iron and manganese is fed to the aeration unit 22 via an inner pipe 25 provided with a plurality of orifices 23 along the length thereof. The aeration unit 22 may also include a middle pipe 26 provided with a plurality of orifices 27 therein. Fluid from inner pipe 25 can be fed to middle pipe 26 via orifices 23 in inner pipe 25. Fluid passing through orifices 23 is impinged on a solid surface 24 of middle pipe 26 as it enters middle pipe 26.

Fluid in middle pipe 26 passes into an outer pipe 28 via orifices 27 and is also impinged on a solid surface 29 of outer pipe 28 after it passes through orifices 27. The aerated fluid may then be fed from outer pipe 28 to a DAF unit 30 via outlet feed 31 which outlet feed 31 may be regulated by a valve 32. In DAF unit 30, the fluid pressure can be lowered to allow the air to nucleate on suspended solids, floating them to the surface. By enhancing the amount of air dissolved, the flotation is thereby enhanced as well, making separation in DAF unit 30 more thorough, efficient and quicker. A stream of solids 33 can be removed from DAF unit 30 leaving a purified water stream 34 which can optionally be fed to a further purification step.

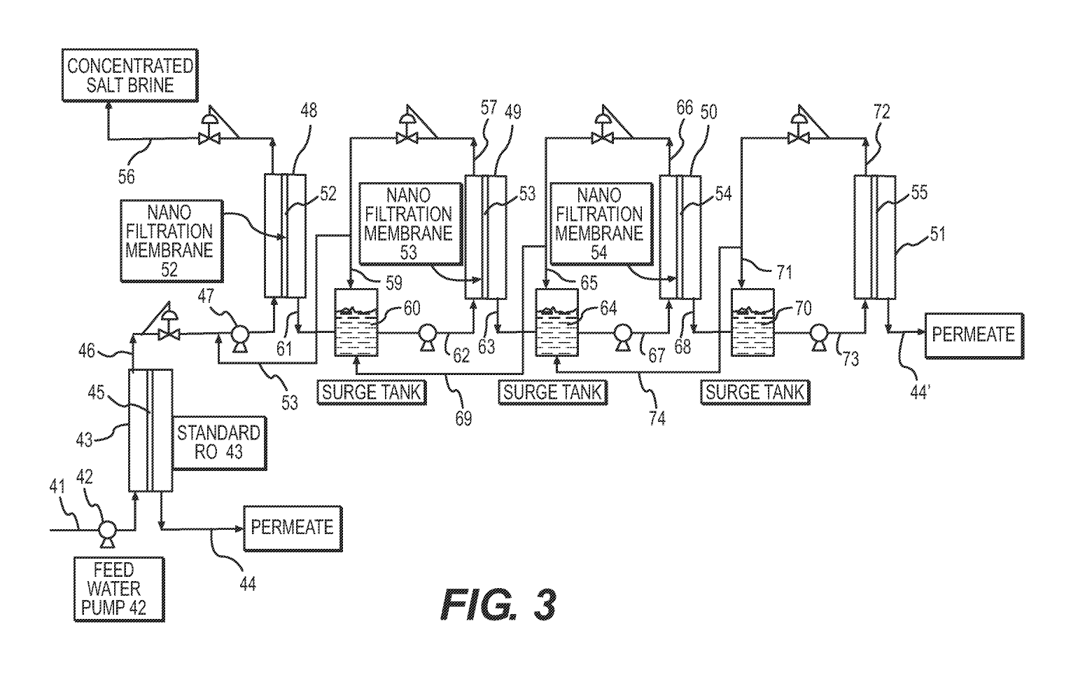

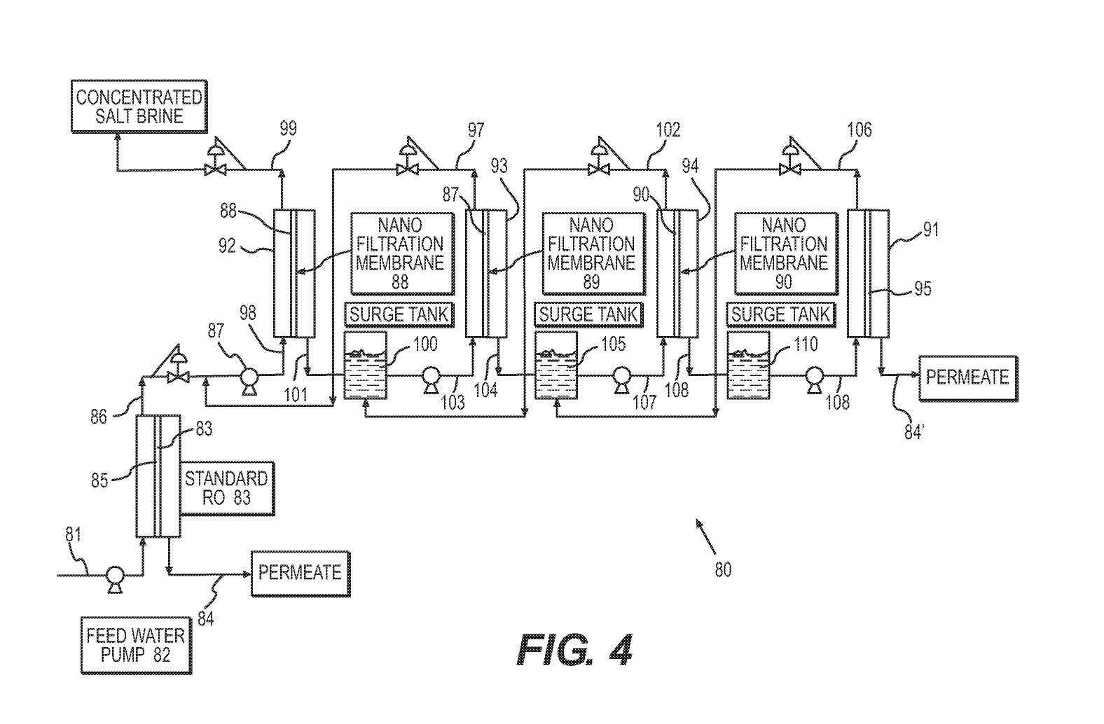

An embodiment of one suitable reverse osmosis system 40 is depicted in FIG. 3 and an alternative embodiment of another suitable reverse osmosis system 70 is depicted in FIG. 4. The embodiments of FIGS. 3-4 employ multiple membrane units, to achieve more concentrated brine solutions. The initial feed water 41 is pumped by feed water pump 42 through a conventional reverse osmosis unit 43 provided with a reverse osmosis membrane 45 and permeate is directed to the clean water discharge 44. The rejectate 46 from RO unit 43 is pumped by rejectate pump 47 to a series of SMU's 48, 49, 50 in which the salt concentration is gradually decreased from close to the solubility limit to a concentration where a single, final RO step in RO unit 51 including an RO membrane 55 will produce clean water at a low pressure. The SMU design offers the ability to operate each of the cascading membranes 52, 53, 54 at a much lower pressure than is currently practiced in traditional RO systems. By operating the SMU's 48, 49, 50 at much lower pressures along with the recycling of rejectate, this design is capable of producing a salt stream at concentrations at or near saturation conditions. Permeate from the final RO unit 51 is sent to the clean water discharge 44′.

The recycling of rejectate is an important feature of this design. The normal RO process rejects the vast majority of the dissolved solids in the water stream. By rejecting only a portion of the dissolved solids in each step of the process of FIG. 3, the pressure drop across each membrane 52, 53, 54, 55 remains in a feasible range. Since the permeate 44′ is essentially pure water, preferably including only a small amount of dissolved solids to support aquatic life, the dissolved solids that pass through each membrane 52, 53, 54, 55 must be transported back to the feed inlet of the initial membrane 52 to exit the system via salt brine outlet 56 as the concentrated salt brine which is the rejectate from membrane 52. To achieve this end, a portion of the rejectate from each membrane 53, 54, 55 is recycled to the inlet of the previous membrane 52, 53, 54 in the series.

This process is shown in detail in FIG. 3. Thus, a portion 58 of the rejectate stream 57 from SMU 49 may be mixed with rejectate 46 from RO unit 43 and recycled directly to SMU unit 48. The remaining portion 59 of rejectate stream 57 from SMU 49 is mixed in surge tank 60 with permeate stream 61 from SMU 48 to form a recycle stream 62 which is recycled to SMU 49. Recycle stream 62 passes through SMU 49 forming rejectate stream 57 and permeate stream 63 which is permeate that passes through membrane 53 of SMU 49.

SMU 50 operates in a manner similar manner to SMU 49. Thus, permeate stream 63 from SMU 49 is mixed in surge tank 64 with a portion 65 of rejectate stream 66 from SMU 50 to form a recycle stream 67 which is recycled to SMU 50. Recycle stream 67 passes through SMU 50 forming rejectate stream 66 and permeate stream 68 which is permeate that passes through membrane 54 of SMU 50. A portion 69 of rejectate stream 66 is also returned to surge tank 60 to form a portion of recycle stream 62 fed to SMU 49, as shown.

Permeate stream 68 is fed to surge tank 70 where it is mixed with a portion 71 of rejectate 72 from RO unit 51 to form a feed stream 73 which is fed to RO unit 51. Another portion 74 of rejectate 72 from RO unit 51 is fed to surge tank 64 to form a portion of recycle stream 67 fed to SMU 50, as shown. By the time feed stream 73 reaches RO unit 51, the salt concentration of feed stream 73 has been reduced to a level whereby the final purification step can be carried out in a conventional RO unit 51 to produce clean water permeate which is taken from RO unit 51 via permeate outlet 44′.

While the rejectate streams 57, 66, 72 will typically be split between being recycled to the current membrane and being recycled to the previous membrane, it is also possible to recycle the entire rejectate stream 57, 66, 73 to the previous membrane inlet. This alternative embodiment of the invention is shown in FIG. 4.

Thus, in the system 80 of FIG. 4, the initial feed water 81 is pumped by feed water pump 82 through a conventional reverse osmosis unit 83 provided with a reverse osmosis membrane 85 and permeate is directed to the clean water discharge 84. The rejectate 86 from the RO unit 83 is pumped by rejectate pump 87 to a series of SMU's 92, 93, 94 in which the salt concentration is gradually decreased from close to the solubility limit to a concentration where a single, final RO step in RO unit 91 including an RO membrane 95 will produce clean water at a low pressure. The SMU design offers the ability to operate each of the cascading membranes 88, 89, 90 at a much lower pressure than is required in traditional RO systems operated at the same feed concentrations. By operating the SMU's 92, 93, 94 at much lower pressures along with the recycling of rejectate, this design is capable of producing a salt stream at concentrations at or near saturation conditions. Permeate from the final RO unit 91 is sent to the clean water discharge 84′.

Rejectate stream 97 from SMU 93 is mixed with rejectate 86 from RO unit 83 and recycled directly to SMU unit 92 as recycle stream 98. Recycle stream 98 passes through SMU unit 92 and to produce rejectate stream 99 and permeate stream 101 which is permeate that passes through membrane 88. Permeate stream 101 is fed to surge tank 100 wherein it is mixed with rejectate stream 102 from SMU 94 to form recycle stream 103 which is fed to SMU 93. Rejectate stream 102 may also be fed into recycle stream 103 directly, without a back pressure regulator or surge tank.

The back pressure regulators and surge tanks shown in FIG. 4 are optional components which can be used to control the flow through the system. These components are useful additions to most systems since they allow the water and salt fluxes across the membranes to vary by providing the ability to store, adjust and/or control flow of various streams to compensate for variations in water or salt flux. In this manner, the streams can be adjusted from time-to-time to the desired concentrations.

SMU 93 operates in a manner similar manner to SMU 92. Thus, permeate stream 104 from SMU 93 is mixed in surge tank 105 with rejectate stream 106 from SMU 94 to form a recycle stream 107 which is recycled to SMU 94. Recycle stream 107 passes through SMU 94 forming rejectate stream 102 and permeate stream 108 which is permeate that passes through membrane 90 of SMU 94. Rejectate stream 102 is returned to surge tank 100 to form a portion of recycle stream 103 fed to SMU 93, as shown.

Permeate stream 108 is fed to surge tank 110. Permeate 108 is the feed stream which is fed to RO unit 91. By the time permeate 108 reaches RO unit 91, the salt concentration of permeate 108 has been reduced to a level whereby the final purification step can be carried out in a conventional RO unit 91 to produce clean water permeate which is taken from RO unit 91 via permeate outlet 84′.

Surge tanks are used in the systems of FIGS. 3-4 to facilitate the startup of the unit and improve the operational control over the system by providing operating flexibility at one or more locations throughout the system. Other control systems, such as suitable valves and one or more additional pumps, may be used in their place, and they are not required for the system to operate properly. The stream 106 may also be mixed with the stream from 105 after the pump to form stream 107, reducing the amount of pumping capacity required by using the pressure of the rejectate leaving RO unit 91 and eliminating the back pressure regulator. In the same manner streams 97 and 102 may be recycled and mixed without reducing the pressure. This will require the pressure in the RO units to decrease in the order of P 91>P 94>P 93>P 92. The difference in pressures between the units can be sufficient to achieve the desired flow rate through the membranes and piping. The outlet 56 for the rejectate may be connected to a device to measure dissolved solids, and release the concentrated salt brine solution at a predetermined set point. This will typically be somewhat less than the solubility limit of the dissolved salts. This set point may be lowered to ease operation of the unit, as required.

The SMU's of the embodiments of FIGS. 3 and 4 are preferably nanofiltration membanes. The nanofiltration membranes are selected to be permeable to some of the salt in the feed, as well as water, in order to allow a salt solution to pass through each of the nanofiltration membranes. Each of the nanofiltration membranes is selected to allow only a portion of the salt in the feed to a particular SMU to pass through the membrane. Also, the nanofiltration membranes are selected such that permeate which passes through each nanofiltration membrane of a particular SMU is a salt solution of lower salt concentration than the rejectate from that SMU. In this manner, the salt concentration in each successive permeate is lowered to a point where permeate from the final SMU can be fed to a standard RO unit to provide an essentially pure water permeate from that standard RO unit.

The NF membranes are selected to have a salt rejection of 10-80%, more preferably, 20-60%. The systems of FIGS. 3-4 can be optimized by selection of particular NF membranes tailored to each stage of the system. In the embodiments of FIGS. 3-4, it is preferable to use two conventional RO units, one to treat the incoming solution directly and one to treat the lower concentration solution that is generated by the NF units of this system. The number of NF units employed in the system may vary depending on the solution to be treated, the particular solute and the degree of concentration required of the system. Thus, the system may include, for example, 1-10 NF units, more preferably, 2-7 NF units and, most preferably, 3-4 NF units. Any number of pumps, valves and surge tanks can be employed in the system to provide the desired level of flow and pressure control. Preferably, the pressure and membranes are selected to maintain a pressure drop across each membrane of less than 1000 psig, more preferably, less than about 750 psig, less than 700 psig or less than 500 psig.

The concentrated salt brine may also be sent to a drier to produce a dry salt product. In such a case the energy usage can immediately be seen to be half as much as the energy required to produce dry salt from a conventional RO outlet solution of half the concentration. Modeling has confirmed these numbers.

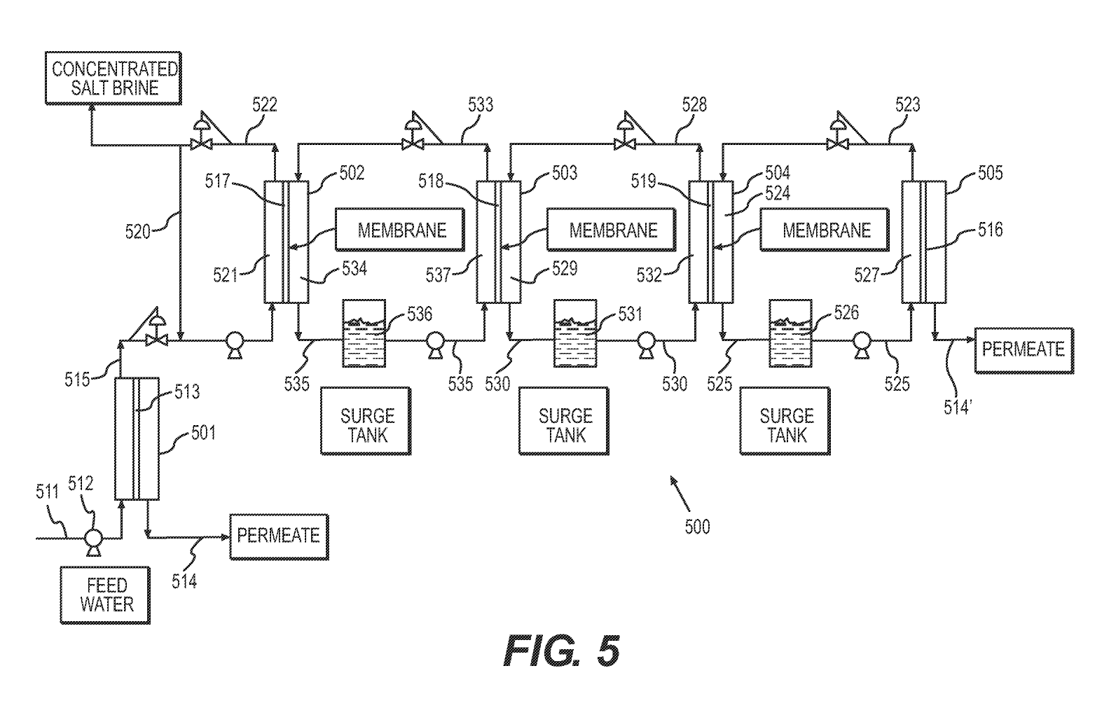

FIG. 5 is a schematic representation of equipment which can be used for a staged RO process in accordance with the present invention for the production of concentrated salt brine and substantially pure water from a salt solution. RO system 500 of FIG. 5 includes multiple RO membrane units 501, 502, 503, 504, 505 to achieve concentrated brine solutions. The initial feed water 511 is pumped by feed water pump 512 through a conventional RO unit 501 provided with a reverse osmosis membrane 513 and permeate is directed to the clean water discharge 514. The rejectate 515 from RO unit 501 is fed to a series of Selective Membrane RO Units (SMROUs) units 502, 503, 504. A single RO step carried out in a conventional RO unit 505 including an RO membrane 516 will produce clean water at a low pressure.

Each SMROU unit 502, 503, 504 includes an RO membrane 517, 518, 519. The rejectate 515 from RO unit 501 may be mixed with concentrated brine solution 520 and fed to the high pressure side 521 of RO membrane 517 to generate a concentrated rejectate 522. A lower concentration solution of the same solute is fed to the low pressure side 523 of RO membrane 517 to bathe the low pressure side 523 of RO membrane 517 with a solution of lower concentration than the solution on the high pressure side 521 of the RO membrane 517. The lower concentration solution is selected to provide an osmotic pressure between the two solutions of about 1.7-7 MPa. In the case of sodium chloride, for example, the higher concentration solution has a solute concentration that is preferably about 2-10 wt %, more preferably, 3-7 wt % lower than the solute concentration of the higher concentration solution high pressure side of the RO membrane.

The SMROU design offers the ability to operate each of the cascading RO membranes 502, 503, 504 at a much lower pressure than is required in traditional single unit RO systems at the outlet concentration of stream 522. By operating the SMROU's 502, 503, 504 at much lower pressures along with the recycling of rejectate, this design is capable of producing a salt stream at concentrations at or near saturation conditions. Permeate from the final RO unit 505 is sent to the clean water discharge 514′.

The recycling of rejectate to the permeate side of the previous SMROU in the system is an important feature of this design. The normal RO process rejects the vast majority of the dissolved solids in the water stream. By cycling the dissolved solids in each step of the process of FIG. 5, the pressure drop across each RO membrane 502, 503, 504 505 remains in a feasible range. Since the permeate desired at clean water discharge 514, 514′ is essentially pure water, preferably including only a small amount of dissolved solids to support aquatic life. The rejectate from each RO membrane 503, 504, 505 is recycled to the inlet of the previous RO unit 502, 503, 504 in the series whereby the salt is essentially trapped in this part of the system with only solution losses and minor flows through the membrane allowing a very small portion of the salt to escape. Some minor bleed may be required at various times during operation of the system due to differences in the salt flux of membranes 516, 517, 518 and 519. The surge tanks can be used to facilitate this.

This process is shown in detail in FIG. 5. Rejectate stream 523 from conventional RO unit 505 is fed to low pressure side 524 of RO membrane 519 of SMROU 504 where it passes through RO unit 504 to provide permeate 525 that is recycled via surge tank 526 to the high pressure side 527 of RO unit 505. Rejectate stream 528 from SMROU 503 is cycled to low pressure side 529 of RO membrane 518 of SMROU 503 where it passes through SMROU 503 to provide permeate 530 that is recycled via surge tank 531 to the high pressure side 532 of SMROU 504. Rejectate stream 533 from SMROU 503 is cycled to low pressure side 534 of RO membrane 517 of SMROU 502 where it passes through SMROU 502 to provide permeate 535 that is recycled via surge tank 536 to the high pressure side 537 of SMROU 503.

By the time feed stream 525 reaches conventional RO unit 505, the salt concentration of feed stream 505 has been reduced to a level whereby the final purification step can be carried out in a conventional RO unit 505 to produce clean water permeate which is taken from RO unit 505 via permeate outlet 514′.

In the system of FIG. 5, it is preferable to use two conventional RO units, one to treat the incoming solution directly to reduce the volume of feed to the remaining units, and one to treat the lower concentration solution that is generated by the SMROU units of this system. The number of SMROU units employed in the system may vary depending on the solution to be treated, the particular solute and the degree of concentration required of the system. Thus, the system may include, for example, 1-10 SMROU units, more preferably, 2-7 SMROU units and, most preferably, 3-4 SMROU units. Any number of pumps, valves and surge tanks can be employed in the system to provide the desired level of flow and pressure control. Preferably, the pressure and membranes are selected to maintain a pressure drop across each membrane of less than about 1000 psig, more preferably, less than about 750 psig, less than about 700 psig or less than about 500 psig.

In another embodiment, a reverse osmosis system may be used in a purification process for produced water from hydrologic gas drilling activities to allow higher concentrations of salt to be achieved in the rejectate. Most reverse osmosis membranes are designed as a spiral wound cartridge. This allows a large surface area in a relatively small volume defined by the cartridge. A shortcoming of the standard spiral wound membranes is that they cannot be used in the stepwise reverse osmosis process of the present invention since the spiral wound membrane cartridges only have only one inlet for the feed solution and two outlets for the permeate and rejectate.

The invention provides spiral wound membranes that may be used in the stepwise reverse osmosis process of the invention, allowing the production of higher salt concentrations with much lower energy costs than with other processes. These membranes may be effectively used in the method of the present invention to produce a solution close to the solubility limits of the salt in the solution.

The present invention provides both a method of producing a flow path that allows recirculation of the process fluids on both the low pressure and the high pressure sides of the reverse osmosis membrane and a reverse osmosis membrane cartridge capable of implementing this method. While two methods of providing this dual flow design are described, other variations may be apparent to a skilled person and are intended to form part of this invention.

This flow path and reverse osmosis membrane cartridge can be used in a staged RO system wherein the low pressure side of each RO membrane is provided with a constant flow of salt containing solution that allows the osmotic pressure to be maintained at a desired level. Since a salt solution is provided on the low pressure side of each RO membrane, the flow of water across the membrane can occur at a lower pressure than would otherwise be required in the absence of a salt solution on the low pressure side of the RO membrane.

In the first embodiment of the instant invention for use in a staged reverse osmosis system, the spiral wound RO membranes are modified from the normal design where the low pressure side opens to a central channel, while the outer end is sealed shut, by replacing the sealed outer end of the RO membrane with a second flow channel similar to the central channel whereby a salt solution may be introduced into this second flow channel to bathe the low pressure side of the RO membrane.

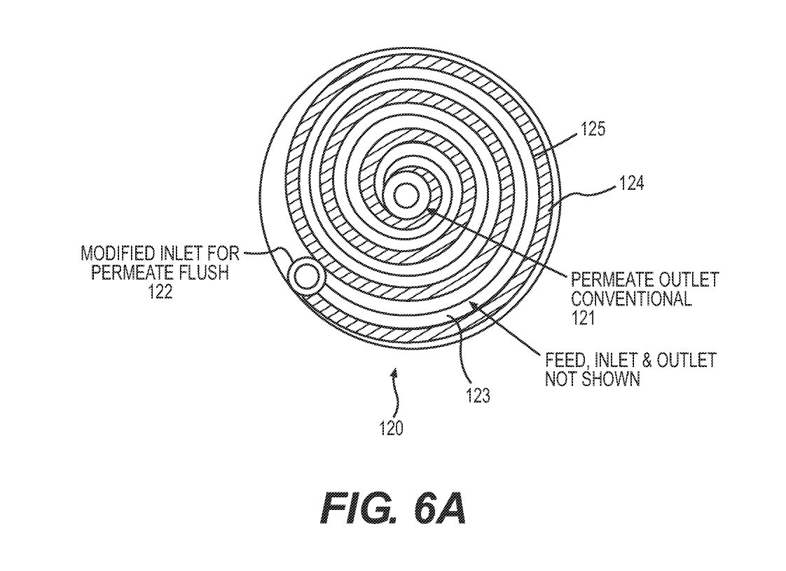

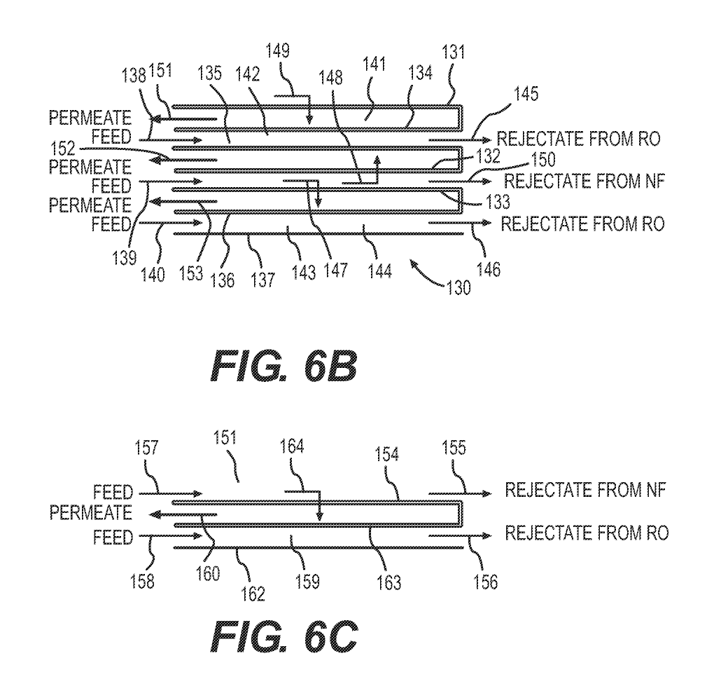

One embodiment of this RO membrane cartridge 120 is shown in FIG. 6A. As seen in FIG. 6A, the conventional permeate outlet 121 is in the center, as in current spiral wound cartridges. At the periphery of RO membrane cartridge 120 is provided an inlet 122 for feeding a solution with lower salt concentration than the salt solution fed to the conventional feed inlet, no shown. The cartridge 120 is sealed as in current spiral wound cartridges. In use, the feed salt solution is fed to the high pressure side 123 of RO membrane 124 and a lower concentration salt solution is fed to the low pressure side 125 of RO membrane 124, preferably in a counter-current flow pattern. Water will pass through RO membrane 124 from high pressure side 123 to low pressure side 125 thereby increasing the salt concentration on high pressure side 123 and decreasing the salt concentration on low pressure side 125. Thus, at permeate outlet 121, the lowest salt concentration solution will be found and at feed outlet, not shown, the highest salt concentration solution will be found.

In another embodiment of the RO membranes of the present invention, the holders for flat reverse osmosis membranes are modified to provide an additional inlet for the recirculation fluid on the low pressure side. The flow path is designed to provide counter-current flow between the high and low pressure fluids. Counter-current flow allows the maximum water flux for removal, and thus is preferred but not necessary to carry out the invention. Also, it is desirable to have water flux across these membranes for them to perform at their optimum level.

The membranes are designed to be employed in special RO units of the invention. In these RO units, the higher concentration salt water is passed on the high pressure side of the membrane, and water passes through the membrane from the high pressure side to the low pressure side where a relatively lower salt concentration solution is provided. This allows passage of water through the RO membrane at much less than the full osmotic pressure of the high concentration salt solution since the lower concentration salt solution on the low pressure side of the membrane reduces the osmotic pressure that must be overcome to pass water through the RO membrane. After passing the solution through multiple such RO units and a final conventional RO unit, the resulting clean water may be discharged, or reused in a subsequent process. If discharged, it may be blended with a suitable amount of RO feed water to provide the necessary electrolytes for aquatic life, and the pH can be adjusted if necessary.

The present invention also relates to an apparatus and method of producing a more concentrated and a less concentrated stream from a solution where the osmotic pressure is too high to allow passage of water through a normal reverse osmosis membrane due to the pressure limitations of the membranes. This is accomplished by providing to the permeate side of the RO membranes enough solute in solution to maintain the osmotic pressure differential across the RO membrane at sufficiently less than the feed pressure to the RO membrane so that the pressure differential across the membrane causes permeate to flow through the membrane, yielding a lower concentration on the permeate side than on the feed side while at the same time the reject solution from the RO membrane is obtained at a higher solution concentration than that of the feed solution.

In this embodiment of the invention, the solute solution is provided to the back side of the RO membrane by a system including a nanofiltration (NF) membrane which preferably allows passage of monovalent ions but not divalent ions. Permeate from the NF membrane is mixed with permeate of the RO membrane to lessen the osmotic pressure differential across the RO membrane. FIG. 6B is a schematic representation of a cross-section of a suitable spiral wound cartridge 130 with layered RO and NF membranes and separate outlets for the rejectate or concentrate, lower concentration permeate, and unchanged feed for use in this embodiment of the invention.

In the embodiment of FIG. 6B are shown three NF membranes 131, 132 and 133 and four RO membranes 134, 135, 136 and 137. Also shown are the inlets 138, 139, 140 for the feed solutions, the outlets 141, 142, 143 for RO permeates, an outlet 144 for NF rejectate and outlets 145, 146 for RO rejectates.

In this system, RO feed streams, which are typically salt solutions, are provided to inlets 138, 140 each located between two RO membranes 134, 135 and 136, 137. Preferably, the feed pressures of each feed stream can be controlled to allow pressure adjustment to optimize the process. Also, the outlet pressure can be controlled using a valve to control back pressure. Water will pass through the RO membranes 134, 135 and 136, 137 as shown by arrows 141, 142, 143, 144 from the RO feed streams provided to inlets 138, 140 to generate more concentrated salt solutions which leave the membrane cartridge 130 via RO rejectate streams 145, 146. At the same time, an NF feed stream, which is also a salt solution, is provided to inlet 139 located between two NF membranes 132, 133. Salt solution from NF feed stream passes through NF membranes 132, 133 as shown by arrows 147, 148. Similarly, salt solution from another NF feed stream passes through NF membrane 131 as shown by arrow 149. The salt solution passing through NF membranes 131, 132, 133 is provided to the low pressure side of RO membranes 134, 135, 136, 137 as shown in FIG. 6B to thereby reduce the osmotic pressure required to pass water from the RO feed streams through the RO membranes 134, 135, 136, 137 and into the salt solution located between the RO membranes 134, 135, 136, 137 and the NF membranes 131, 132, 133. Since the NF feed stream mainly contains monovalent cations, the salt concentration of this stream does not vary significantly as a result of being passed along NF membranes 131, 132, 133 and thus the NF rejectate has a similar composition to the NF feed stream. The rejectate from NF membranes 132, 133 leaves membrane cartridge 130 via NF rejectate outlet 150. Permeate through RO membranes 134, 135, 136, 137 mixes with permeate through NF membranes 131, 132, 133 and leaves membrane cartridge 130 via permeate outlets 151, 152, 153.

To further illustrate this approach, a single cell is depicted in FIG. 6C. FIG. 6C is a schematic representation of a cross-section of a single layer from the spiral wound cartridge with layered RO and NF membranes. The dotted lines 161, 162 show the boundary of a single cell consisting of a RO membrane 163 next to a NF membrane 154. There is an NF rejectate outlet 155 and an RO concentrate outlet 156, as well as an NF feed inlet 157 and an RO feed inlet 158. As can be seen, lower concentration permeate passes through RO membrane 163 at arrow 159 and leaves via permeate outlet 160, and the substantially unchanged NF feed to NF inlet 157 leaves via NF rejectate outlet 155. Salt solution passes through NF membrane 154 as shown by arrow 164 and is thereby provided to the low pressure side of RO membrane 163 in order to reduce the osmotic pressure required to pass water through RO membrane 163 as shown by arrow 159. In this manner, more concentrated salt solutions can be obtained as RO rejectate than would be possible using conventional RO membranes without a salt solution located on the low pressure side of the membrane. The flow through NF membrane 154 at arrow 164 is high in salt concentration, while the flow at arrow 159 through the RO membrane 163 is close to pure water.

In one embodiment of the system of FIGS. 6A-6C, the feed stream has an 11 wt % solute concentration, the solution on the low pressure side of the RO membrane has an average solute concentration of about 4-6 wt % and the rejectate from the RO membrane will have a solute concentration of about 14 wt %.

The membrane cartridge 130 of FIGS. 6A-6C can be implemented in the form of a staged system, in which case the low pressure side of the RO membrane must have a constant flow of salt-containing solution that allows the osmotic pressure across the membrane to be reduced, relative to the situation where there is no solution on the low pressure side of the RO membrane. This permits the flow of solvent, typically water, across the membrane to occur at a lower pressure than would otherwise be required.

In one embodiment of the instant invention for use in a staged RO system, the spiral wound membranes are modified from the normal design by alternating RO membranes with NF membranes that allow at least a portion of the dissolved solids to pass through the membrane and mix with the pure solvent produced from the RO membrane, giving a somewhat diluted solution, as shown in FIGS. 6A-6C.

While it is preferable to separate the rejectate from the NF membranes from the concentrated rejectate from the RO membranes, this is not a requirement of the invention. Embodiments of the system design with and without this separation are described below. Also, it is not necessary to have the membranes in the spiral wound configuration for implementation of the invention. The membranes may also be in a flat or other suitable configuration. In the case that the membranes are in the flat configuration, the holders for the flat RO membranes are modified to provide an inlet for feed fluid on the low pressure side, and separate outlets are provided for each of the two rejectate flows as well as an outlet for the permeate flow. The flow path is preferably designed to provide co-current flow between permeates from the NF and RO membranes, so that the concentration of permeate is maintained as uniform as possible.

The membranes are designed to be employed in Selective Membrane RO Units (SMROU's). In such SMROU's, highly concentrated salt solution is passed on one side of the RO membrane, and water is passed through the RO membrane to the lower salt concentration side at much less than the full osmotic pressure of the highly concentrated solution, due to the presence of a lower concentration salt solution on the low pressure side of the RO membrane. After multiple such SMROU's, the resulting clean solvent may be discharged, or reused in a subsequent process. If discharged, it may be blended with a suitable amount of RO feed water to provide the necessary electrolytes for aquatic life, and the pH adjusted if necessary.

In order to make the most efficient design of the SMROU, the rate of permeation through the RO and NF membranes must be matched to provide the desired permeate concentration at a useful and achievable inlet pressure. As an alternative, the membranes may be designed so that the NF and RO membranes are fed at different pressures, and/or at different concentrations, to achieve the desired balance in flow rates between the NF and RO permeate streams Having too low a flow through the NF membrane relative to the desired flow through the RO membrane will result in reduced flow through the RO membrane due to the presence of insufficient salt solution on the low pressure side of the RO membrane. Having too high a flow rate through the NF membrane will result in the need for additional stages due to the amount of salt that will be delivered through the NF membrane to the permeate, but a lowered pressure drop in each stage. The selection of the NF membranes is thus an important aspect of the invention.

The NF membranes are selected to have a salt rejection of 0-80%, more preferably, 0-40%. The systems of FIGS. 3-4 and 6-8 can be optimized by selection of particular NF membranes tailored to each stage of the system.

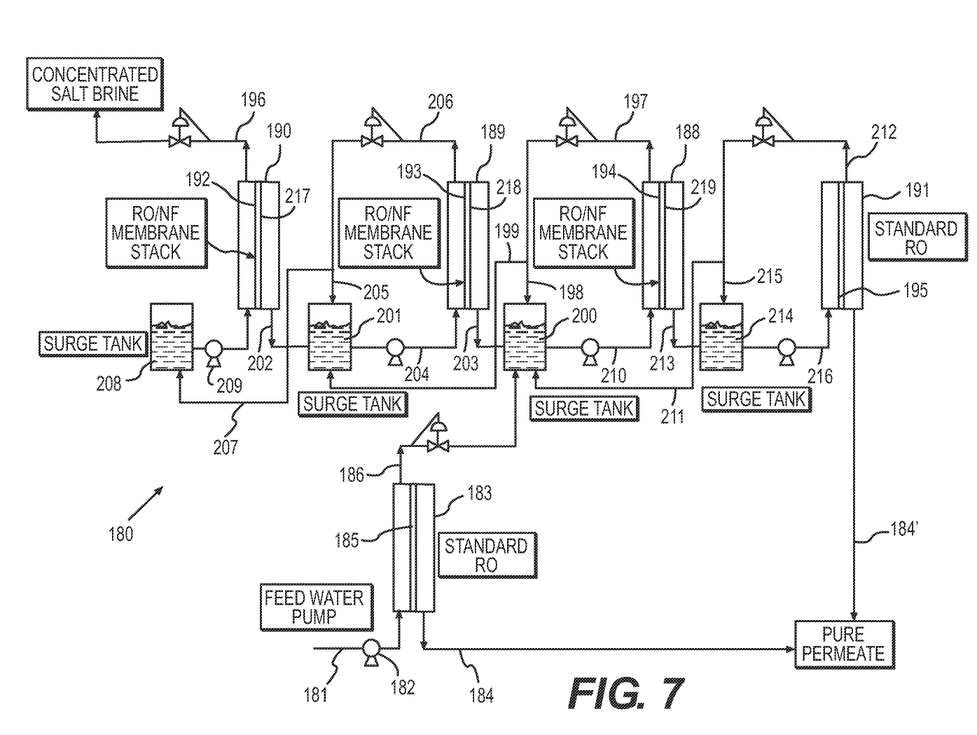

In order to make most effective use of the membrane design, it is a requirement to design the supporting equipment in such a way as to take advantage of the properties of the membrane design. In particular, it is preferred to move the solvent and solute in a counter-current manner through the system. It is also desirable to also minimize the complexity and size of the equipment used, although this trade-off must be balanced by parameters of the particular water purification application. One such arrangement according to the invention is depicted in FIG. 7.

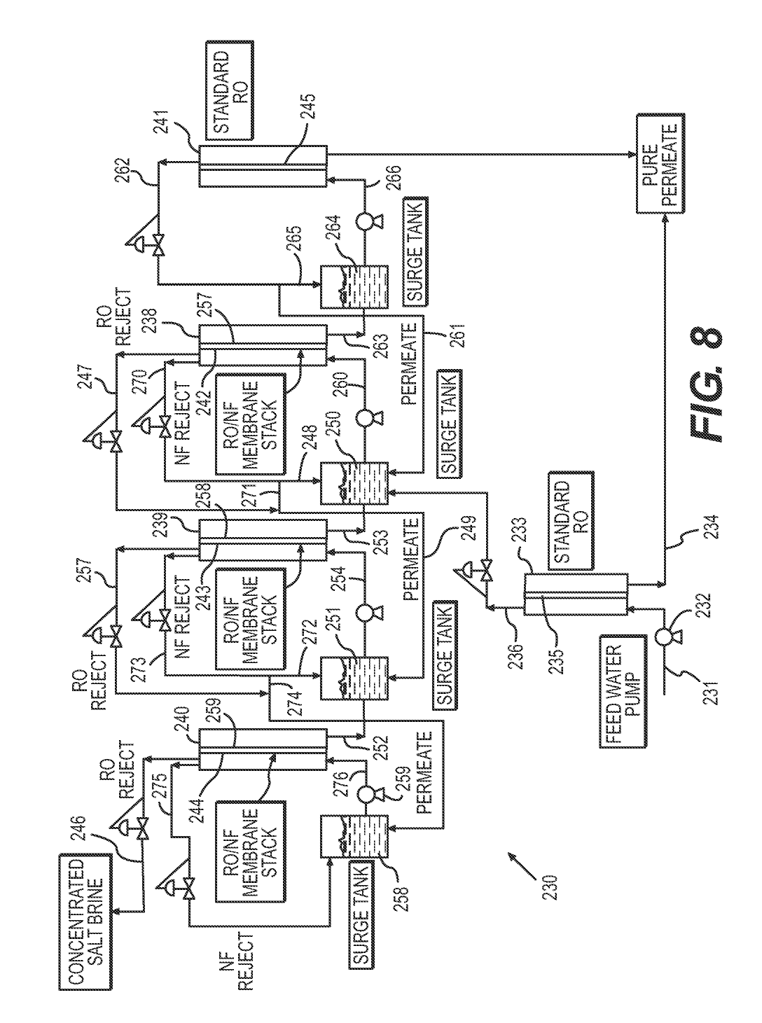

The system in FIG. 7 is one way of designing the equipment to take advantage of the advantages of the membrane design, but other systems are envisioned as well. In the system of FIG. 7, the rejectate flows from the RO and NF membranes are combined. In another embodiment, depicted in FIG. 8, the rejectate flows from the RO and NF membranes are kept separate and routed to different locations to make use of the differences in the concentrations of the rejectates from the different membranes. The rejectate from the RO membrane is a more concentrated salt solution than the rejectate from the NF membrane. The RO membrane rejectate is thus sent to a loop processing a more dilute salt solution, while the NF rejectate is recycled in the same processing loop.

Referring to FIG. 7, there is shown a flow diagram of one embodiment of an RO system 180 for water purification and generation of concentrated salt brine which employs the membrane arrangement of FIG. 6C of the present application. The embodiment of FIG. 7 employs multiple membrane units 183, 188, 189, 190, 191 to achieve more concentrated brine solutions. The initial feed water 181 is pumped by feed water pump 182 through a conventional RO unit 183 provided with a reverse osmosis membrane 185 and permeate is directed to the clean water discharge 184. The rejectate 186 from the RO unit 183 is fed to a series of SMROU units 188, 189, 190. A single RO step carried out in a conventional RO unit 191 including an RO membrane 195 will produce clean water at typical operating pressures for an RO unit.

Each SMROU unit 188, 189, 190 includes an RO/NF membrane stack. Thus, SMROU unit 188 includes an RO membrane 192 and an NF membrane 217, SMROU unit 189 includes an RO membrane 193 and an NF membrane 218 and SMROU unit 190 includes an RO membrane 194 and an NF membrane 219. The feed to each SMROU unit 188, 189, 190 is fed to both the high pressure side of RO membranes 192, 193, 194 and the side of NF membranes 217, 218, 219 facing away from NF membranes 217, 218, 219. Salt solution permeate will flow from the feed through NF membranes 217, 218, 219 to mix with permeate through the RO membranes 192, 193, 194 and bathe the low pressure side of RO membranes 192, 193, 194 with a salt solution of lower concentration than the solution on the high pressure side of the RO membranes 192, 193, 194 which lower concentration salt solution is formed as a result of permeate flow through RO membranes 192, 193, 194 and mixing of this permeate with the salt solution permeate passing through NF membranes 217, 218, 219 on the low pressure side of RO membranes 192, 193, 194.

The SMROU design offers the ability to operate each of the cascading RO membranes 192, 193, 194 at a much lower pressure than is required in traditional RO systems, and which is within the pressure limitations of current membranes. By operating the SMROU's 188, 189, 190 at much lower pressures along with the recycling of rejectate, this design is capable of producing a salt stream at concentrations at or near saturation conditions. Permeate from the final RO unit 191 is sent to the clean water discharge 184′.

The recycling of rejectate is an important feature of this design. The normal RO process rejects the vast majority of the dissolved solids in the water stream. By rejecting only a portion of the dissolved solids in each step of the process of FIG. 7, the pressure drop across each RO membrane 192, 193, 194, 195 remains in a feasible range. Since the permeate desired at clean water discharge 184, 184′ is essentially pure water, preferably including only a small amount of dissolved solids to support aquatic life, the dissolved solids that are rejected by each RO membrane 192, 193, 194, 195 must be transported back to the feed inlet of the RO unit 190 to exit the system via salt brine outlet 196 as the concentrated salt brine which is the rejectate from RO membrane 192 and may have a solute concentration of, for example, about 21-22 wt %, when the solute is sodium chloride. To achieve this end, a portion of the rejectate from each RO membrane 193, 194, 195 is recycled to the inlet of the previous RO unit 188, 189, 190 in the series. In this manner the salt flux through the unit is maintained at a net rate of close to zero, while the water flux continues to move the water through the unit to the clean water outlet 184′.

This process is shown in detail in FIG. 7. Rejectate stream 186 from conventional RO unit 183 is fed to surge tank 200 where it is mixed with: (1) a portion 198 of the rejectate stream 197 from SMROU 188, (2) the combined RO membrane 193 permeate, NF membrane 218 permeate and NF membrane 218 rejectate outlet stream 203 from SMROU 189, and (3) a portion 211 of rejectate stream 212 from RO unit 191 and recycled directly to SMROU unit 188 as recycle stream 210 which may have a sodium chloride concentration of, for example, about 10-11 wt %. The remaining portion 199 of rejectate stream 197 from SMROU 188 is mixed in surge tank 201 with the combined RO membrane 192 permeate, NF membrane 217 permeate and NF membrane 217 rejectate outlet stream 202 from SMROU 190 and a portion 205 of rejectate stream 206 from SMROU 189 which is recycled as feed stream 204 to SMU 189, which may have a sodium chloride concentration of, for example, about 14-15 wt %. Another portion 207 of rejectate stream 206 from SMROU 189 is directed to surge tank 208 and subsequently pumped by pump 209 to SMROU 190. The feed to SMROU 190 may have a sodium chloride concentration of, for example, 18-19 wt %. Recycle stream 210 passes through SMU 188 forming rejectate stream 197 and combined RO membrane 194 permeate, NF membrane 219 permeate and NF membrane 219 rejectate outlet stream 213 which is fed to surge tank 214 where it is mixed with a portion 215 of rejectate stream 212 to form feed stream 216 that is fed to RO unit 191.

By the time feed stream 216 reaches RO unit 191, the sodium chloride concentration of feed stream 216 has been reduced to a level, such as about 6-7 wt %, whereby the final purification step can be carried out in a conventional RO unit 191 to produce clean water permeate which is taken from RO unit 191 via permeate outlet 184′.

The system of FIG. 8 is similar to the system of FIG. 7 except that the combined RO membrane permeate and NF membrane permeate from each SMROU is not mixed with the NF membrane rejectate from that SMROU but instead these two streams are routed separately to different locations in the system.

Referring to FIG. 8, there is shown a flow diagram of one embodiment of an RO system 230 for water purification and generation of concentrated salt brine which employs the membrane arrangement of FIG. 6C of the present application. The embodiment of FIG. 8 employs multiple membrane units 233, 238, 239, 240, 241 to achieve more concentrated brine solutions. The initial feed water 231 is pumped by feed water pump 232 through a conventional RO unit 233 provided with a reverse osmosis membrane 235 and permeate is directed to the clean water discharge 234. The rejectate 236 from the RO unit 233 is fed to a series of SMROU units 238, 239, 240. A single RO step carried out in a conventional RO unit 241 including an RO membrane 245 will produce clean water at a low pressure.

Each SMROU unit 238, 239, 240 includes an RO/NF membrane stack. Thus, SMROU unit 238 includes an RO membrane 242 and an NF membrane 257, SMROU unit 239 includes an RO membrane 243 and an NF membrane 258 and SMROU unit 240 includes an RO membrane 244 and an NF membrane 259. The feed to each SMROU unit 238, 239, 240 is fed to both the high pressure side of RO membranes 242, 243, 244 and the side of NF membranes 257, 258, 259 facing away from NF membranes 257, 258, 259. Salt solution permeate will flow from the feed through NF membranes 257, 258, 259 to mix with permeate through the RO membranes 242, 243, 244 and bathe the low pressure side of RO membranes 242, 243, 244 with a salt solution of lower concentration than the solution on the high pressure side of the RO membranes 242, 243, 244 which lower concentration salt solution is formed as a result of permeate flow through RO membranes 242, 243, 244 and mixing of this permeate with the salt solution permeate passing through NF membranes 257, 258, 259 on the low pressure side of RO membranes 242, 243, 244.

The SMROU design offers the ability to operate each of the cascading RO membranes 242, 243, 244 at a much lower pressure than is required in traditional RO systems. By operating the SMROU's 238, 239, 240 at much lower pressures along with the recycling of rejectate, this design is capable of producing a salt stream at concentrations at or near saturation conditions. Permeate from the final RO unit 241 is sent to the clean water discharge 234′.

The recycling of rejectate is also an important feature of this design. The normal RO process rejects the vast majority of the dissolved solids in the water stream. By rejecting only a portion of the dissolved solids in each step of the process of FIG. 8, the pressure drop across each RO membrane 242, 243, 244, 245 remains in a feasible range. Since the permeate desired at clean water discharge 234, 234′ is essentially pure water, preferably including only a small amount of dissolved solids to support aquatic life, the dissolved solids that are rejected by each RO membrane 242, 243, 244, 245 must be transported back to the feed inlet of the RO unit 240 to exit the system via salt brine outlet 246 as the concentrated salt brine which is the rejectate from RO membrane 242. To achieve this end, the rejectate from each RO membrane 243, 244, 245 is recycled to the inlet of the previous RO unit 238, 239, 240 in the series. In addition, since the NF membrane rejectate streams have different concentrations than the combined stream of the RO membrane permeate and NF membrane permeate, the embodiment of FIG. 8 routes these streams to different locations in the RO system 230 to take advantage of these concentration differences.

This process is shown in detail in FIG. 8. Rejectate stream 236 from conventional RO unit 233 is fed to surge tank 250 where it is mixed with: (1) a portion 248 of the NF rejectate stream 270 from SMROU 238, (2) the combined RO membrane 243 permeate and NF membrane 258 permeate outlet stream 253 from SMROU 239, and (3) a portion 261 of rejectate stream 262 from RO unit 241 and recycled directly to SMROU unit 238 as recycle stream 260. The remaining portion 271 of NF rejectate stream 27 from SMROU unit 238 is mixed with the RO rejectate outlet stream 247 from SMROU 238 to form a combined stream 249 which is fed to surge tank 258. Combined stream 249 is mixed in surge tank 251 with: (1) the combined RO membrane 244 permeate and NF membrane 259 permeate outlet stream 252 from SMROU unit 240, (2) a portion 272 of NF rejectate stream 273 from SMROU 239, and is recycled as feed stream 254 to SMROU 239. Another portion 274 of NF rejectate stream 273 from SMROU 239 is mixed with RO rejectate 257 and directed to surge tank 258 where it is mixed with NF rejectate stream 275 from SMROU 240 to form a combined recycle stream 276 which is subsequently pumped by pump 259 to SMROU 240. Recycle stream 260 passes through SMROU 238 forming rejectate stream 247 and combined RO membrane 242 permeate, NF membrane 259 permeate outlet stream 263 which is fed to surge tank 264 where it is mixed with a portion 265 of rejectate stream 262 to form feed stream 266 that is fed to RO unit 241.

By the time feed stream 266 reaches RO unit 241, the salt concentration of feed stream 266 has been reduced to a level whereby the final purification step can be carried out in a conventional RO unit 241 to produce clean water permeate which is taken from RO unit 241 via permeate outlet 234′.

The startup of the systems shown in FIGS. 7 and 8 may be accomplished by starting the pumps only when the surge tanks they draw from have sufficient water to support the flow rate of the pump. In this way, the system can be controlled to generate the proper concentrations in the various streams and surge tanks as it runs. Initially, the initial RO unit is started and this unit will fill the surge tank it discharges into. Once this tank is sufficiently filled, and the pump started, it will fill the two adjacent surge tanks, allowing those pumps to start. Once those start, the final surge tank will begin filling, allowing the start of the final pump. This phased startup is part of the advantage of this invention. Other minor design modifications to make use of the staged concept using NF/RO membranes are readily apparent, and are intended as part of the invention set forth herein. A benefit of the embodiments of FIGS. 7 and 8 of the present invention is the ability to remove total dissolved solids from contaminated waters in a more cost effective manner than other removal methods, producing pure water and a very highly concentrated salt solution.

In the systems of FIGS. 7-8, it is preferable to use two conventional RO units, one to treat the incoming solution directly and one to treat the lower concentration solution that is generated by the NF units of this system. The number of SMROU units employed in the system may vary depending on the solution to be treated, the particular solute and the degree of concentration required of the system. Thus, the system may include, for example, 1-10 SMROU units, more preferably, 2-7 SMROU units and, most preferably, 3-4 SMROU units. Any number of pumps, valves and surge tanks can be employed in the system to provide the desired level of flow and pressure control. Preferably, the pressure and membranes are selected to maintain a pressure drop across each membrane of less than about 1000 psig, more preferably, less than about 750 psig, less than about 700 psig or less than about 500 psig.

Each of the systems of the present invention may use any combination of pumps, valves and/or surge tanks to regulate flow and/or pressure in the system in order to optimize system operating parameters. Useful locations for pumps, valves and surge tanks are shown in the drawings. Many modifications and variations on the use and locations of pumps, valves and surge tanks can be implemented within the scope of the present invention. Also, the invention can be adapted for use in other industrial facilities wherein forward or reverse osmosis processes are employed such as for removal of organic materials from water. The invention provides the ability to overcome issues that may arise due to high osmotic pressures that may be encountered in certain types of reverse osmosis processes.

In another embodiment, the present invention uses osmosis, either forward or reverse, to produce a solution from which crystallization may proceed. This embodiment of the present invention allows crystallization to occur without the need for evaporation. The unsaturated solution is fed to a chamber containing a supersaturated solution and mixed. One boundary of the chamber may be an osmotic membrane which allows the solvent to pass through the membrane, but not the solute. On the other side of the osmotic membrane is a solution with higher osmotic potential than the supersaturated solution. This may be created by dissolving a more soluble salt or gas in the same solvent, or using a solvent which cannot pass through the membrane but is miscible with the solvent in the supersaturated solution. In this way, the solvent is drawn by osmotic pressure through the osmotic membrane from the supersaturated solution, enhancing the crystallization of the solute.

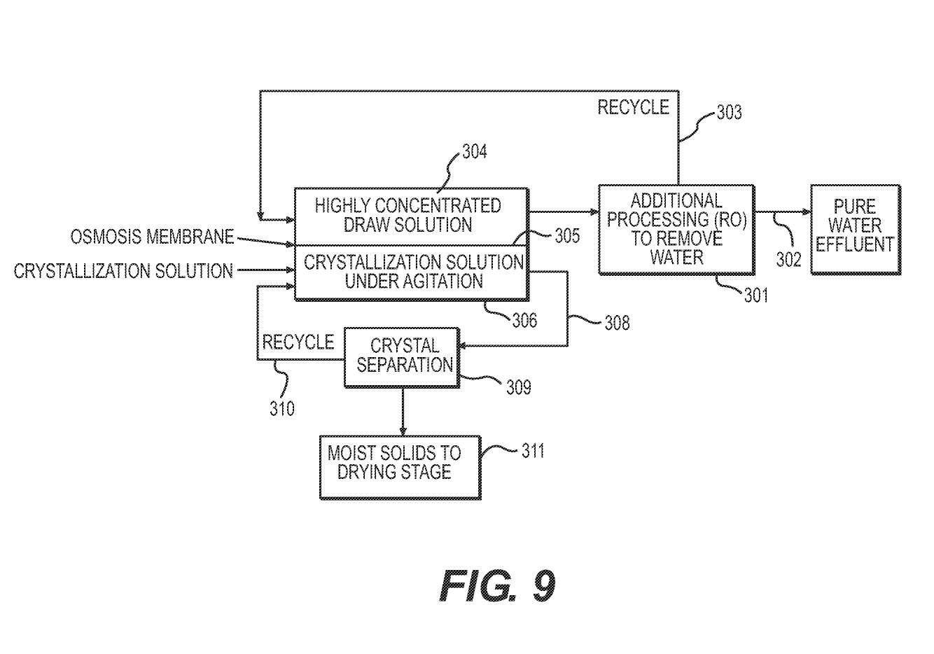

An example of this embodiment of the invention is depicted in FIG. 9. Thus, in this embodiment, the crystallization system 300 of the present invention can be employed, for example, in conjunction with one of the systems of FIGS. 3-4 and 7-8 above or some other alternative system for removing water from an aqueous solution of a crystallizable material. Referring to FIG. 9, crystallization system 300 will typically be implemented in conjunction with another system such as an RO membrane system 301 which produces a substantially pure water effluent 302 and an RO membrane rejectate 303. RO membrane rejectate 303, in the case of sodium chloride, is typically a high concentration solution having a solute concentration of about 2-8 wt %, more preferably, 3-7 wt % higher than the solute concentration of the crystallization solution 307 fed to crystallization container 306. RO membrane rejectate 303 is used as a feed solution to the low pressure side 304 of osmotic membrane 305. Crystallization container 306 is located adjacent to, and has one wall formed from, osmotic membrane 305. Crystallization solution 307 typically has a solute concentration in the vicinity of the supersaturated concentration, and, depending on the characteristics of the solute being crystallized, may be as much as 3-5% above the saturation concentration, but is preferably less than 1% above the saturation concentration.

Solvent will flow across osmotic membrane 305 from crystallization solution 307 to RO membrane rejectate 303 as a result of osmotic pressure across osmotic membrane 305. As a result of locating a relatively concentrated solution on the low pressure side 304 of osmotic membrane 305, the solute concentration gradient between crystallization solution 307 and RO membrane rejectate 303 is maintained within the operational limits of osmotic membrane 305, in a manner similar to that discussed above in relation to the embodiments of FIGS. 7-8 of the present application.

Agitation is applied to the crystallization solution 307 in any suitable manner, such as those discussed below to ensure continued mixing of crystallization solution 307 in the vicinity of osmotic membrane 305 which will be continuously losing solvent across osmotic membrane 305, with the bulk crystallization solution 307 located at a distance from osmotic membrane 305. In this manner, nucleation on a surface of osmotic membrane 305 can be reduced or prevented. Additionally, in preferred embodiments the bulk crystallization fluid 307 is seeded to favor crystallization on the surfaces of the seed crystals over crystallization on a surface of osmotic membrane 305.

A combined stream 308 of solution and crystals exits the crystallization container and is fed to a suitable crystal separation device 309. Filtration or any other conventional crystal separation means can be employed in crystal separation device 309. Liquid from crystal separation device 309 can be recycled to crystallization container 306 via recycle stream 310. Moist solids including the desired solute crystals are also removed from crystal separation device 309 and are preferably dried in a moist solids drying stage 311.

To prevent plugging and fouling of the membrane, the supersaturated solution is agitated, and preferably seeded with crystals to discourage nucleation of the solute at the surface of the membrane. Sufficient agitation is required to move the supersaturated solution from the surface of the membrane into the bulk fluid while not permitting nucleation at the surface of the osmotic membrane. This agitation may be provided by the crystallizing fluid flowing through the area adjacent to the osmotic membrane, as in a membrane cell, and/or by mechanical agitation in a larger container where the osmotic membrane makes up a portion of the container boundary.

The manner of introduction of the solution to the crystallization container may be used to agitate the container, by, for example, directing a jet of material toward the osmotic membrane. The purpose of the agitation is to reduce or eliminate the concentration gradient from the osmotic membrane surface to the bulk fluid, to thereby minimize the nucleation of crystals at the membrane surface, as well as to remove nucleated crystals before they plug the osmotic membrane. The agitation may also be imparted by simple mechanical agitation of the bulk fluid or by a combination of mechanical agitation of the bulk fluid and the manner of introduction of the solution to the crystallization container.

In a more preferred design, the agitation is imparted by an impeller specifically designed to create turbulence at the surface of the osmotic membrane. In such an arrangement, the osmotic membrane can be formed into a cylindrical shape, with the impeller either just inside or just outside the cylinder of the osmotic membrane. As the impeller rotates, it forces solution toward the osmotic membrane, and then away from the osmotic membrane, creating turbulent flow at the osmotic membrane surface to maximize the mass transfer rates and to minimize the size of the boundary layer at the membrane surface. This mass transfer minimizes supersaturation at the surface of the osmotic membrane, thereby reducing nucleation of new crystals at or on the surface of the osmotic membrane.

While a circular or cylindrical design is easiest to visualize, it is also possible to use a flat membrane, and rather than a circular impeller, use a flat sheet formed with the appropriate cross-section to produce the same effect. The sheet membrane may be oscillated to provide the motion required to cause the fluid to flow toward, and then away from the surface of the osmotic membrane, in order to prevent or reduce nucleation at the surface of the osmotic membrane.

The membrane may be oriented horizontally, vertically, or in a different configuration. The membrane may also be installed in a manner much like a balloon, where the internal pressure maintains the size and shape of the membrane like an inflated balloon. Thus, it is not necessary to have the membrane fixed in position, but the membrane may be made to flex by changing the pressure in the two compartments separated by the membrane so that movements of the membrane itself provide agitation to the liquids at the surfaces of the membrane. Pulsing of the pressure at the proper frequency and amplitude will cause ripples in the surface of the membrane, effectively transporting the high concentration solution generated near the membrane into the bulk phase and away from the surface of the membrane. By having seed crystals in the bulk solution, the supersaturation of the fluid may be maintained at a value below the level which would result in nucleation of new crystals, allowing the membrane surface to remain substantially free of solids.

Additional agitation may be obtained by mechanically moving the membrane, such as in a circular motion or by mechanically flexing the membrane or by mechanically vibrating the membrane. In some instances, the membrane may need additional stiffness, and may be made from a ceramic material, or supported by ceramic or other structural materials. The agitation may also be imparted by a scraper or impeller rotating inside a membrane having, for example, a circular cross-section.

In one version of the design, the membrane is supported by a highly porous rigid structure that absorbs the mechanical force of the differential pressure across the membrane. As some positive pressure is needed to cause the fluid to flow across the membrane, the membrane support can be fabricated to provide openings of small cross-sectional area that allow the membrane to withstand the pressure differential without failure and yet permit passage of the fluid across the membrane. One example of a suitable support is a wire mesh screen, but the support may be more elaborate, such as a with a flat plate machined with a multiplicity of small openings closely spaced to allow for a maximum inflow area while still providing the required structural support to the membrane.

The present invention also relates to a process for the crystallization of solutes from solution which comprises the following steps:
a) introduction of the unsaturated solution into a solution at or very near saturation, with the presence of seed crystals in the unsaturated solution,
b) circulation of the resulting solution through a container with an osmotic membrane as a boundary,
c) drawing a portion of the solvent from the nearly saturated solution using forward or reverse osmosis, bringing the concentration of the solute to above the saturation concentration and allowing crystallization to proceed,
d) providing sufficient agitation to maintain the supersaturated solution below the auto-nucleation point,
e) removing at least a portion of the solution from the container and separating out at least a portion of the wet crystals from the solution, returning a portion to the process, and
f) Providing sufficient agitation to the solution to prevent nucleation of the solute at the surface of the osmotic membrane.
   The wet crystals may be dried after removal from the solution. The seed crystals in the recycle stream may be reduced in size (and increased in number) before recycle of the recycle stream. The membrane may be a horizontal or vertical sheet separating the upper draw solution from the lower crystallization solution. The membrane may be a flexible membrane and need not be fixed in space to separate the draw solution from the crystallization solution. The pressure may be pulsed to provide additional agitation of the crystallization solution by flexing the membrane. Alternatively agitation may be provided by either constant or intermittent motion of the membrane, by the flow of the fluid over the surface of the membrane, by a mechanical agitator, by a reticulated foam structure in motion close to the surface of the membrane, but sufficiently far away from the membrane to prevent damage the membrane, by an impeller in close proximity to the membrane which alternately moves solution toward and away from the membrane at a rapid rate or any combination thereof. The impeller may be used to produce turbulence at the surface of the membrane to enhance mass transfer of the solute away from the membrane and solvent to the surface of the membrane.

The membrane may be a polymer based osmotic membrane capable of passing the solvent molecules but not the solute molecules which are desired to produce crystals. Alternatively, the membrane may be selected to pass solutes other than the solute desired to be crystallized. The membrane can also be a ceramic based osmotic membrane capable of passing the solvent molecules but not the solute molecules which are desired to produce crystals.

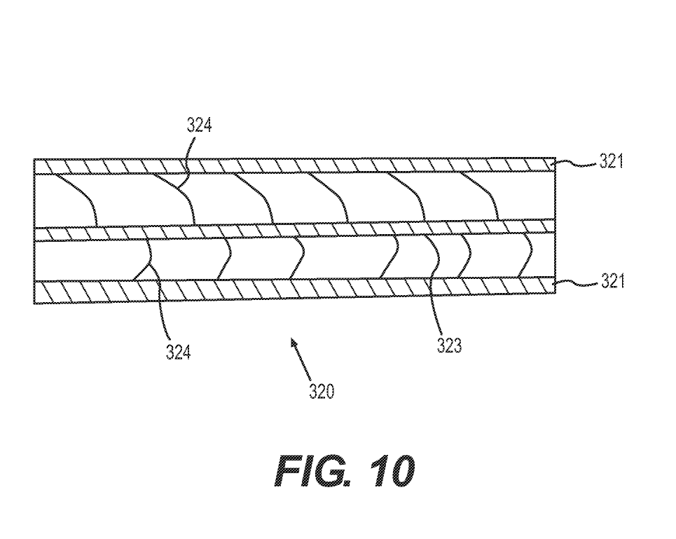

FIG. 10 depicts a cross-sectional view of one embodiment of a crystallization container 320 in accordance with the invention. An impeller including a shaft 323 and impeller blades 324 is mounted within crystallization container 320 to provide mixing of the crystallization solution in crystallization container 320.

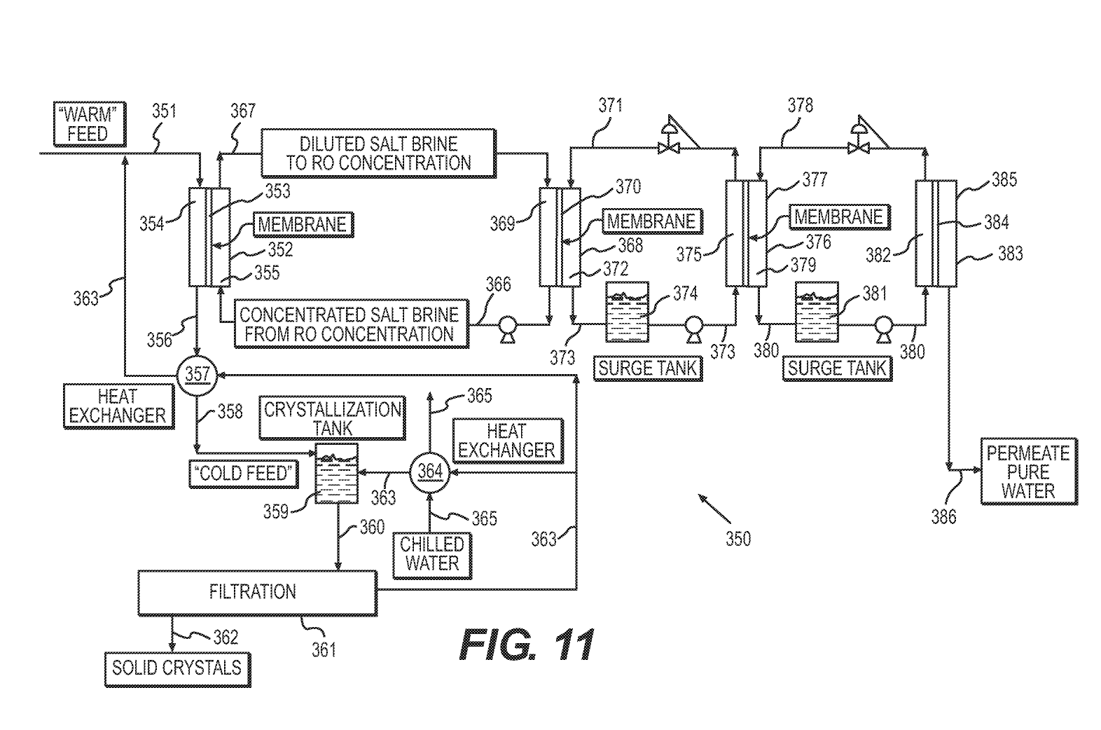

FIG. 11 shows an alternative embodiment of a reverse osmosis apparatus 350 for carrying out a concentration process for crystallization of solute from solution. A nearly saturated solution 351 is fed to a RO unit 352 with suitable agitation. RO unit 352 has an osmotic membrane 353 that forms a boundary of chamber 354 to which the nearly saturated solution is fed. Osmotic membrane 353 allows solvent to pass through the membrane 353 but not the solute. On the other, low pressure side 355 of osmotic membrane 353 is a solution with a higher osmotic potential than the nearly saturated solution for forward osmosis, or within 1.7 MPa for low pressure reverse osmosis. The solution located on low pressure side 355 of osmotic membrane 353 may be created in the same manners as mentioned above. In this way, the solvent is drawn by osmotic pressure through osmotic membrane 353 to low pressure side 355 from the solution on the high pressure side in chamber 354 until the solution approaches saturation. To prevent fouling of osmotic membrane 353, the nearly saturated solution is agitated thoroughly and removed from RO unit chamber 354 before it becomes supersaturated.

The solution 356 may be cooled or heated, depending on the solubility curve for the particular solute in question, by a heat exchanger 357 to cause it to become supersaturated. The cooled or heated solution 358 may then be fed to a crystallization vessel such as crystallization tank 359 where at least some of the solute crystallizes out of solution. A portion of the contents of crystallization tank 359 are removed and the crystals 360 are fed to a filtration device 351 or, alternatively, to a centrifugation device (not shown) or other conventional device for separating crystals from solution in order to provide a product stream 262 of solid crystals. The liquid solution 363 from filtration device 361 is recycled to either or both of heat exchanger 357 and heat exchanger 364, In heat exchanger 364 heat is exchanged with chilled water 365 (in the case that cooling is required to cause crystallization) and then the liquid solution 363 is fed back into crystallization tank 359. In heat exchanger 357, liquid solution 363 can be used as the cooling fluid for heat exchange with solution 356 and then liquid solution 363 may then be fed back into the system as part of nearly saturated solution 351 as shown.

The solution used to draw solvent from the RO feed stream is passed through a staged RO process such as those described above in relation to FIGS. 3-4 and 7-8 to extract substantially pure solvent without the need for evaporation at any point in the process. A concentrated solution 366 is fed to the low pressure side 352 of RO unit 352. This solution 366 is selected to provide an osmotic pressure across the membrane of from about 1.7 to about 7 MPa, more preferably, from about 1.7 to about 4.0 MPA. In the case of sodium chloride, solution 366 has a solute concentration that is preferably about 2-10 wt %, more preferably, 3-7 wt % lower than the solute concentration of the nearly saturated solution 351 fed to high pressure side chamber 354 of RO unit 352. Permeate through RO membrane 353 mixes with concentrated solution 366 to form a diluted solution 367 which exits RO unit 352 and is fed to the high pressure side 369 of another RO unit 368 provided with an RO membrane 370 which allows passage of substantially only solvent therethrough. A concentrated RO membrane rejectate 366 is taken out of RO unit 368 and recycled to RO unit 352.

A concentrated solution 371 is fed to low pressure side 372 of RO unit 368. This solution 371 is selected to provide an osmotic pressure across the membrane of from about 1.7 to about 7 MPa, more preferably, from about 1.7 to about 4.0 MPA. In the case of sodium chloride, solution 371 has a solute concentration that is preferably about 2-10 wt %, more preferably, 3-7 wt % lower than the solute concentration of the diluted solution 367 fed to high pressure side chamber 369 of RO unit 368. Permeate through RO membrane 370 mixes with concentrated solution 371 to form a diluted solution 373 which exits RO unit 368 and is fed to surge tank 374 and subsequently to the high pressure side 375 of another RO unit 376 provided with an RO membrane 377 which allows passage of substantially only solvent therethrough. A concentrated RO membrane rejectate 371 is taken out of RO unit 376 and recycled to RO unit 368.

A concentrated solution 378 is fed to low pressure side 379 of RO unit 376. This solution 378 is selected to provide an osmotic pressure across the membrane of from about 1.7 to about 7 MPa, more preferably, from about 1.7 to about 4.0 MPA. In the case of sodium chloride, solution 378 has a solute concentration that is preferably about 2-10 wt %, more preferably, 3-7 wt % lower than the solute concentration of the solution 373 fed to high pressure side chamber 375 of RO unit 376. Permeate through RO membrane 377 mixes with concentrated solution 378 to form a diluted solution 380 which exits RO unit 376 and is fed to surge tank 381 and subsequently to the high pressure side 382 of a conventional RO unit 383 provided with an RO membrane 384 which allows passage of substantially only solvent therethrough. A concentrated RO membrane rejectate 378 is taken out of conventional RO unit 383 and recycled to RO unit 376. A substantially pure water permeate is taken from low pressure side 385 of conventional RO unit 383 and provided to purified water outlet 386.

The small crystals in the recycle to the RO unit 352 will likely redissolve, preventing fouling of the RO membrane 353. However, in the first stage of the RO process, the membrane may be oriented or configured to minimize crystal formation in the same manner as discussed above.

The present invention also relates to a process for the crystallization of solutes from solution which comprises the following steps:
a) circulation of an unsaturated solution through a chamber of an RO unit with an osmotic membrane as a boundary,
b) drawing a portion of the solvent from the nearly saturated solution using forward or reverse osmosis, bringing the concentration of the solute proximate to the saturation concentration,
c) providing sufficient agitation to prevent nucleation of the solute at the surface of the osmotic membrane,
d) removing at least a portion of the solution from the RO chamber,
e) changing the temperature to cause the solution to become supersaturated and form crystals,
f) separating out at least a portion of the wet crystals from the solution, and returning the solution to the crystallization process, and
g) using a staged RO process to produce substantially pure solvent from a stream taken from said crystallization process.
   The wet crystals may be dried after removal from the solution. The seed crystals in the recycle stream may be reduced in size (and increased in number) before recycle of the recycle stream. The membrane may be a horizontal or vertical sheet separating the upper draw solution from the lower crystallization solution. The membrane may be a flexible membrane and need not be fixed in space to separate the draw solution from the crystallization solution. The pressure may be pulsed to provide additional agitation of the crystallization solution by flexing the membrane. Alternatively agitation may be provided by either constant or intermittent motion of the membrane, by the flow of the fluid over the surface of the membrane, by a mechanical agitator, by a reticulated foam structure in motion close to the surface of the membrane, but sufficiently far away from the membrane to prevent damage to the membrane, by an impeller in close proximity to the membrane which alternately moves solution toward and away from the membrane at a rapid rate or any combination thereof. The impeller may be used to produce turbulence at the surface of the membrane to enhance mass transfer of the solute away from the membrane and solvent to the surface of the membrane.

The membrane may be a polymer based osmotic membrane capable of passing the solvent molecules but not the solute molecules which are desired to produce crystals. Alternatively, the membrane may be selected to pass solutes other than the solute desired to be crystallized. The membrane can also be a ceramic based osmotic membrane capable of passing the solvent molecules but not the solute molecules which are desired to produce crystals.

The invention will now be further illustrated by the following non-limiting examples.

### Example 1

An experiment was performed to show that membrane concentration of salt can be achieved at lower reverse osmotic pressure by counter-flowing a salt solution on the permeate side of the membrane rather than pure water. A single membrane system was selected such that the concentrate side operated at 50 psi and the permeate side operated at atmospheric pressure. A solution of sodium chloride (0.24 M or approximately 1.4%) was flowed from a reservoir on the concentrate side at 50 psi and the same concentration of sodium chloride solution was flowed in a counter-flow direction from a separate reservoir on the permeate side operating at atmospheric pressure. The pressure of 50 psi was selected because it is significantly lower than the expected osmotic pressure resulting from a 1.4% salt solution (150 psi); meaning the 50 psi reverse osmosis pressure was insufficient to overcome the expected osmotic pressure if the permeate side was pure water.

The system was operated for 30 hours and intermittent samples were collected from both the concentrate side outlet and the permeate side outlet. The samples were tested for salt concentration using a conductivity meter. If there was no flow across the membrane, after 30 hours of operation the salt concentrations would have been equal on both sides of the membrane. In fact, a higher concentration was observed on the concentrate side (about 2% higher relative) and a lower concentration was observed on the permeate side (about 2% lower relative). The precision of the conductivity measurement was determined on a sample of sodium chloride solution with approximately the same concentration as the test samples and was found to be 0.03% RSD (n=5).

### Example 2

A system including a first RO membrane unit employing a conventional RO membrane and two SMROUs each employing a conventional RO membrane, similar to a portion of the embodiment shown in FIG. 5 of the present application, was tested for salt concentration and water purification using sodium chloride solutions.

The sodium chloride concentration in the stream fed to the inlet of the first RO membrane unit was 3%. The concentrate exiting the first RO membrane unit had a salt concentration of about 10%. The 10% concentrated solution from the first RO membrane unit was mixed with a 22% salt solution to provide a salt solution having a concentration of about 18% which was then fed to the high pressure side of the RO membrane of an SMROU unit. A flush/permeate having a salt concentration of about 14% was fed to the low pressure side of the RO membrane of the SMROU unit. The 14% solution was diluted to a solution having about an 11% salt concentration on the low pressure side of the RO membrane as a result of permeate flow across the RO membrane from the high pressure side. The 18% solution on the high pressure side of the RO membrane was concentrated to about a 21% salt concentration.

### Example 3

In a short field test of a portion of a system similar to that shown in FIG. 5, a 7.25% sodium chloride solution obtained from the first RO membrane flowing at 1.2 GPM was combined with a 22% solution of sodium chloride flowing at 2.4 GPM. The 22% solution originated from the concentrated brine vessel. The combined stream (17.2% sodium chloride) entered the concentrate inlet side of a first SMROU at a flow rate of 3.6 GPM and the concentrate from the first SMROU was fed to the concentrate inlet side of a second SMROU from which it exited at a sodium chloride concentration of 24.8% and a flow rate of 2.5 GPM. On the permeate side of the first SMROU an 11% sodium chloride solution entered the SMROU at a flow rate of 3 GPM and exited the permeate side as an 8% sodium chloride solution and at a flow rate of 4.12 GPM. The 11% sodium chloride solution originated from the concentrate side of a second SMROU unit. In this particular test, the target concentration of 22% was exceeded by 2.8%.

### Example 4

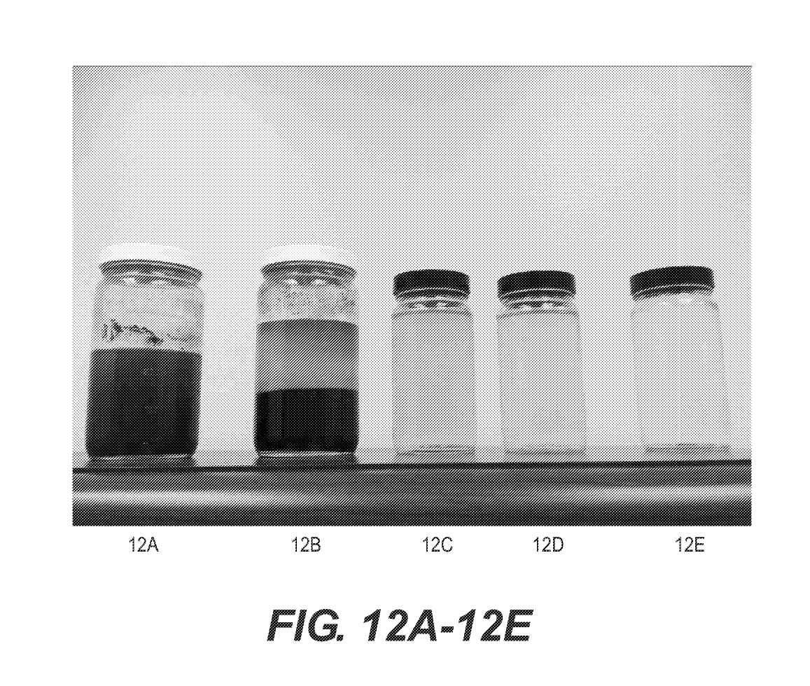

Used frac water was subjected to purification using several of the steps described in FIG. 1. More particularly, the used frac water, shown in FIG. 12A was first fed to a DAF unit similar to that described in relation to FIG. 2 of the present application and material was skimmed off from the DAF tank, which material is shown in FIG. 12B. The purified product from the DAF tank is shown in FIG. 12C. The purified product from the DAF tank was then filtered through a 1 micron filter, and the filtrate obtained from the 1 micron filter is shown in FIG. 12D. The filtrate shown in FIG. 12 D was then filtered through a 0.45 micron filter and the filtrate obtained from the 0.45 micron filter is shown in FIG. 12E.

The foregoing examples have been presented for the purpose of illustration and description only and are not to be construed as limiting the invention in any way. The scope of the invention is to be determined from the claims appended hereto.

1. A reverse osmosis system for treatment of a feed solution is fed through said plurality of membrane units to produce a highly concentrated solute stream and a substantially pure water stream comprising:
a plurality of membrane units each containing at least one membrane, said membrane units being arranged in series and there being a sufficient number of membrane units to ensure that a pressure drop across each membrane is maintained within operational limits by spreading a total pressure drop for said system across said plurality of membrane units, and
a recycle system for recycling solution from each membrane unit to a previous membrane unit in said series.

2. The reverse osmosis system of claim 1, wherein a first membrane in said series is configured to have a low solute rejection and each successive membrane in said series is configured to have a successively higher solute rejection.

3. The reverse osmosis system of claim 2 where the final membrane in said series is a standard reverse osmosis membrane producing essentially pure solvent from a solution.

4. The reverse osmosis system of claim 3 where additional water is blended with the reverse osmosis permeate to produce a water stream meeting the water standards for discharge to streams.

5. The reverse osmosis system as claimed in claim 1, further comprising a surge tank located in between each pair of membrane units.

6. The reverse osmosis system of claim 1, wherein the pressures and rejection rates of the membranes are selected so that the pressure drop across each membrane is less than about 1000 psig.

7. The reverse osmosis system of claim 1, wherein the pressures and rejection rates of the membranes are selected so that the pressure drop across each membrane is less than about 750 psig.

8. The reverse osmosis system of claim 1, wherein at least one membrane unit includes an additional inlet channel on a low pressure side of the membrane for a recirculated solute solution.

9. The reverse osmosis system of claim 8, wherein the inlet is constructed of polymer, steel, or ceramic material.

10. The reverse osmosis system of claim 1, wherein at least one membrane unit includes alternate layers of reverse osmosis membrane and nanofiltration membrane such that permeate from the two membranes mixes in close proximity to a surface on a low pressure side of the reverse osmosis membrane.

11. The reverse osmosis system of claim 10, wherein at least one of the membrane units has separate outlets for the reject fluid from each of the nanofiltration and reverse osmosis membranes.

12. The reverse osmosis system of claim 10, wherein at least one of the membrane units has separate inlets for feed to the nanofiltration and reverse osmosis membranes.

13. The reverse osmosis system of claim 13, including structure for operating the nanofiltration and reverse osmosis membranes at different pressures.

14. A process for treatment of a feed solution produce a highly concentrated solute stream and a substantially pure water stream comprising the steps of:
a) passing the feed solution through a first reverse osmosis membrane unit to produce a permeate and a rejectate, and
b) passing the rejectate from said first reverse osmosis membrane unit through at least a second reverse osmosis membrane unit on a high pressure side of a reverse osmosis membrane to produce a permeate and a rejectate, wherein a solute solution creating an osmotic pressure difference of 1.7-7 MPa with said rejectate is passed along a low pressure side of said reverse osmosis membrane of said at least a second reverse osmosis membrane unit to maintain a pressure drop across said reverse osmosis membrane of less than about 1000 psig.

15. The process of claim 14, further comprising the step of drying the concentrated solute stream to produce a dry product by heating the concentrated solute stream under pressure and flashing solvent away from the solute in a low pressure flash vessel.

16. The process of claim 14, wherein the feed solution is a salt solution.

17. The process of claim 14, wherein the feed solution is frac water or a component of frac water.

18. The process of claim 14, further comprising the step of passing the rejectate from the second reverse osmosis membrane unit through at least a third reverse osmosis membrane unit on a high pressure side of a reverse osmosis membrane to produce a permeate and a rejectate, wherein a solute solution creating an osmotic pressure difference of 1.7-7 MPa with said rejectate is passed along a low pressure side of said reverse osmosis membrane of said at least a third reverse osmosis membrane unit to maintain a pressure drop across said reverse osmosis membrane of less than about 100 psig.

19. The process of claim 18, further comprising the step of passing the rejectate from the third reverse osmosis membrane unit through at least a fourth reverse osmosis membrane unit on a high pressure side of a reverse osmosis membrane to produce a permeate and a rejectate, wherein a solute solution creating an osmotic pressure difference of 1.7-7 MPa with said rejectate is passed along a low pressure side of said reverse osmosis membrane of said at least a fourth reverse osmosis membrane unit to maintain a pressure drop across said reverse osmosis membrane of less than about 100 psig.

20. The process of claim 14, further comprising the step of passing the permeate from the second reverse osmosis membrane unit through another reverse osmosis membrane unit to produce substantially pure water and a rejectate.
